(19) United States
(12) Patent Application Publication
(10) Pub. No.: US 2026/0128802 A1
(43) Pub. Date: May 7, 2026

(54) SYSTEM INCLUDING A PASSIVE OPTICAL NETWORK

(71) Applicant: ARRIS Enterprises LLC, Horsham, PA (US)

(72) Inventors: David BOWLER, Stow, MA (US); Shawn W. WARNER, Pepperell, MA (US); Erik J. GRONVALL, Bloomington, MN (US); David GRUBB, Bethlehem, PA (US); Jeffrey W. WEBER, Randolph, NJ (US)

(73) Assignee: ARRIS Enterprises LLC, Horsham, PA (US)

(21) Appl. No.: 19/105,288

(22) PCT Filed: Aug. 23, 2023
(86) PCT No.: PCT/US23/30976

§ 371 Date: Feb. 20, 2025

Related U.S. Application Data
(60) Provisional application No. 63/403,493, filed on Sep. 2, 2022.
(60) Provisional application No. 63/404,875, filed on Sep. 8, 2022.
(60) Provisional application No. 63/409,028, filed on Sep. 22, 2022.
(60) Provisional application No. 63/430,178, filed on Dec. 5, 2022.
(60) Provisional application No. 63/431,862, filed on Dec. 12, 2022.
(60) Provisional application No. 63/435,478, filed on Dec. 27, 2022.

(51) Int. Cl. H04B 10/80; H04B 10/27

(52) U.S. Cl. CPC H04B 10/80; H04B 10/27

(57) ABSTRACT

A system including a passive optical network.

### CROSS REFERENCE TO RELATED APPLICATIONS

This application claims the benefit of U.S. Patent Application Ser. No. 63/431,862 filed Dec. 12, 2022 entitled INTERCONNECTED PASSIVE OPTICAL NETWORK AND WIRELESS SYSTEMS;

claims the benefit of U.S. Patent Application Ser. No. 63/435,478 filed Dec. 27, 2022 ENTITLED SMALL CELL DENSIFICATION FOR A PASSIVE OPTICAL NETWORK;

claims the benefit of U.S. Patent Application Ser. No. 63/430,178 filed Dec. 5, 2022 entitled DEPLOYMENT SYSTEMS FOR MODULAR PASSIVE OPTICAL NETWORKS;

claims the benefit of U.S. Patent Application Ser. No. 63/409,028 filed Sep. 22, 2022 entitled SELECTIVE VIRTUALIZED PROCESSING FOR PON NETWORKS;

claims the benefit of U.S. Patent Application Ser. No. 63/404,875 filed Sep. 8, 2022 entitled MANAGEMENT OF PON NETWORKS;

claims the benefit of U.S. Patent Application Ser. No. 63/403,493 filed Sep. 2, 2022 ENTITLED OPTIMIZED HFC AND PON INTEGRATED NETWORK.

### BACKGROUND

The subject matter of this application relates to a system including a passive optical network.

A passive optical network (PON) is often employed as an access network, or a portion of a larger communication network. The communication network typically has a high-capacity core portion where data or other information associated with telephone calls, digital television, and Internet communications is carried substantial distances. The core portion may have the capability to interact with other networks to complete the transmission of telephone calls, digital television, and Internet communications. In this manner, the core portion in combination with the passive optical network enables communications to and communications from subscribers (or otherwise devices associated with a subscriber, customer, business, or otherwise).

The access network of the communication network extends from the core portion of the network to individual subscribers, such as those associated with a particular residence location (e.g., business location). The access network may be wireless access, such as a cellular network, or a fixed access, such as a passive optical network or a cable network.

Referring to FIG. 1, in a PON 10, a set of optical fibres and passive interconnecting devices are used for most or all of the communications through the extent of the access network. A set of one or more optical network terminals (ONTs) 11 are devices that are typically positioned at a subscriber's residence location (e.g., or business location). The term “ONT” includes what is also referred to as an optical network unit (ONU). There may be any number of ONTs associated with a single optical splitter 12. By way of example, 32 or 64 ONTs are often associated with the single network optical splitter 12. The optical splitter 12 is interconnected with the respective ONTs 11 by a respective optical fiber 13, or otherwise a respective fiber within an optical fiber cable. Selected ONTs may be removed and/or added to the access network associated with the optical splitter 12, as desired. There may be multiple optical splitters 12 that are arranged in a cascaded arrangement.

The optical fibers 13 interconnecting the optical splitter 12 and the ONTs 11 act as access (or “drop”) fibers. The optical splitter 12 is typically located in a street cabinet or other structure where one or more optical splitters 12 are located, each of which are serving their respective set of ONTs. In some cases, an ONT may service a plurality of subscribers, such as those within a multiple dwelling unit (e.g., apartment building). In this manner, the PON may be considered a point to multipoint topology in which a single optical fiber serves multiple endpoints by using passive fiber optic splitters to divide the fiber bandwidth among the endpoints.

An optical line terminal (OLT) 14 is located at the central office where it interfaces directly or indirectly with a core network 15. An interface 16 between the OLT 14 and the core network 15 may be one or more optical fibers, or any other type of communication medium. The OLT 14 forms optical signals for transmission downstream to the ONTs 11 through a feeder optical fiber 17, and receives optical signals from the ONTs 11 through the feeder optical fiber 17. The optical splitter 12 is typically a passive device that distributes the signal received from the OLT 14 to the ONTs 11. Similarly, the optical splitter 12 receives optical signals from the ONTs 11 and provides the optical signals though the feeder optical fiber 17 to the OLT 14. In this manner, the PON includes an OLT with a plurality of ONTs, which reduces the amount of fiber necessary as compared with a point-to-point architecture.

As it may be observed, an optical signal is provided to the feeder fiber 17 that includes all of the data for the ONTs 11. Accordingly, all the data being provided to each of the ONTs is provided to all the ONTs through the optical splitter 12. Each of the ONTs selects the portions of the received optical signals that are intended for that particular ONT and passes the data along to the subscriber, while discarding the remaining data. Typically, the data to the ONTs are time divisional multiplexed to the feeder fiber 17, and similarly time division multiplexed to each of the ONTs.

Upstream transmissions from the ONTs 11 through the respective optical fibers 13 are typically transmitted in bursts according to a schedule provided to each ONT by the OLT. In this way, each of the ONTs 11 will transmit upstream optical data at different times. In some embodiments, the upstream and downstream transmissions are transmitted using different wavelengths of light so that they do not interfere with one another. In this manner, the PON may take advantage of wavelength-division multiplexing, using one wavelength for downstream traffic and another wavelength for upstream traffic on a single mode fiber.

The schedule from the OLT allocates upstream bandwidth to the ONTs. Since the optical distribution network is shared, the ONT upstream transmission would likely collide if they were transmitted at random times. The ONTs typically lie at varying distances from the OLT and/or the optical splitter, resulting in a different transmission delay from each ONT. The OLT measures the delay and sets a register in each ONT to equalize its delay with respect to the other ONTs associated with the OLT. Once the delays have been accounted for, the OLT transmits so-called grants in the form of grant maps to the individual ONTs. A grant map is a permission to use a defined interval of time for upstream transmission. The grant map is dynamically recalculated periodically, such as for each frame. The grant map allocates bandwidth to all the ONTs, such that each ONT receives timely bandwidth allocation for its service needs. Much of the data traffic, such as browsing websites, tends to have bursts and tends to be highly variable over time. By way of a dynamic bandwidth allocation (DBA) among the different ONTs, a PON can be oversubscribed for upstream traffic.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates a network that includes a passive optical network.

FIG. 2 illustrates a passive optical network with downstream data traffic.

FIG. 3 illustrates a passive optical network with upstream data traffic.

FIG. 4 illustrates a remote OLT.

FIG. 5 illustrates an exemplary OLT.

FIG. 6 illustrates a vOLT and OLT.

FIG. 7 illustrates an ONT and a wireless unit together with an antenna.

FIG. 8 illustrates an ONT included in an enclosure.

FIG. 9 illustrates a plate.

FIG. 10 illustrates an ONT, a wireless unit, and an antenna.

FIG. 11 illustrates configurations of an ONT, a wireless unit, and an antenna.

FIG. 12 illustrates an ONT, wireless unit, and antenna.

FIG. 13 illustrates a housing with a fiber optic interconnection.

FIG. 14 illustrates a set of telephone poles and sparse housings.

FIG. 15 illustrates a housing with a tap, an ONT, a wireless unit, and an antenna.

FIG. 16 illustrates a housing with a detachably engageable tap, an ONT, a wireless unit, and an antenna.

FIG. 17 illustrates an access network with a node.

FIG. 18 illustrates service groups for an access network.

FIG. 19 illustrates splitters and taps for an access network.

FIG. 20 illustrates a modified access network.

FIG. 21 illustrates FLM based segmentation.

FIG. 22 illustrates feeder network based segmentation.

FIG. 23 illustrates a testing unit for an access network.

FIG. 24 illustrates a debugging for an access network.

FIG. 25 illustrates a debugging for an access network.

FIG. 26 illustrates a build of materials for a new customer.

FIG. 27 illustrates a determination for modification of an access network.

FIG. 28 illustrates a FEC encoding process.

FIG. 29 illustrates a FEC encoding process.

FIG. 30 illustrates a FEC decoding process.

FIG. 31 illustrates a FEC decoding process.

FIG. 32 illustrates a PON based latency determination.

FIG. 33 illustrates a latency based OLT DBA.

FIG. 34 illustrates a latency based vOLT DBA.

FIG. 35 illustrates selective image processing.

FIG. 36 illustrates processing for YANG data models using OMCI.

FIG. 37 illustrates processing for PON networks.

FIG. 38 illustrates YANG requests and responses.

FIG. 49 illustrates request for usage statistics.

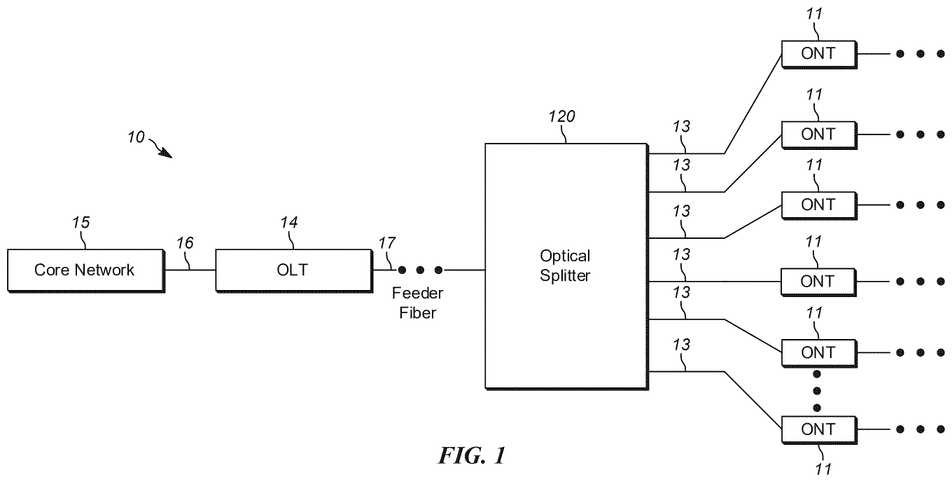

FIG. 40 illustrates a leaf-spine network for a PON network.

FIG. 41 illustrates network congestion determination.

FIG. 42 illustrates geographic based routing of data.

FIG. 43 an integrated cable modem termination system.

FIGS. 44A and 44B illustrate distributed cable modem termination systems.

FIG. 45 illustrates an exemplary cable network.

FIG. 46 illustrates a network that includes a passive optical network.

FIG. 47 illustrates a passive optical network with downstream data traffic.

FIG. 48 illustrates a passive optical network with upstream data traffic.

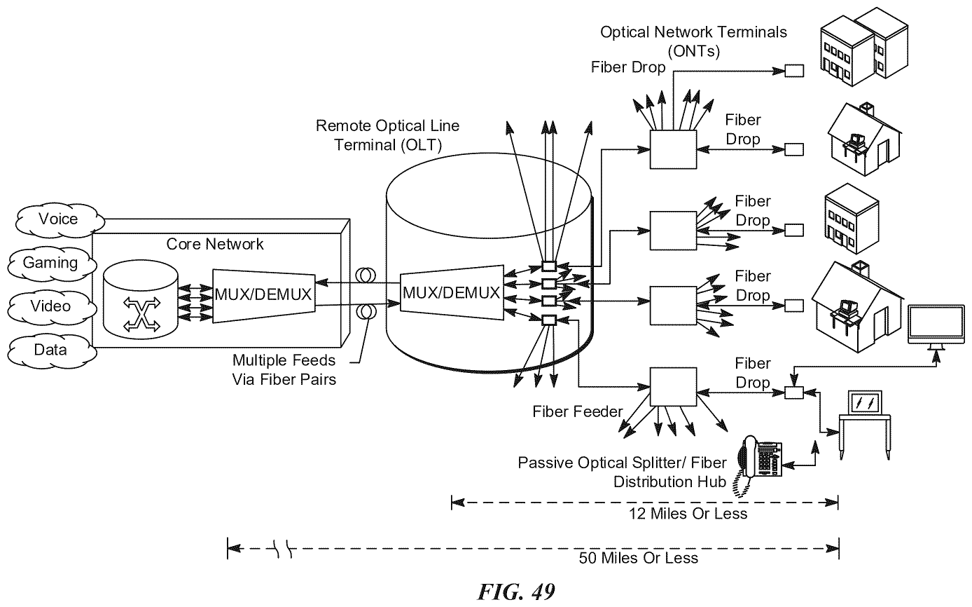

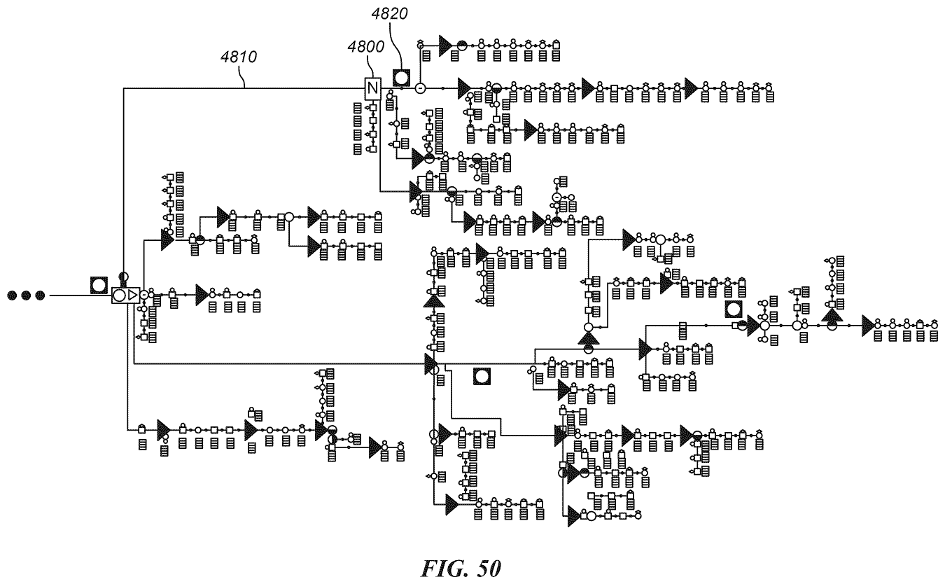

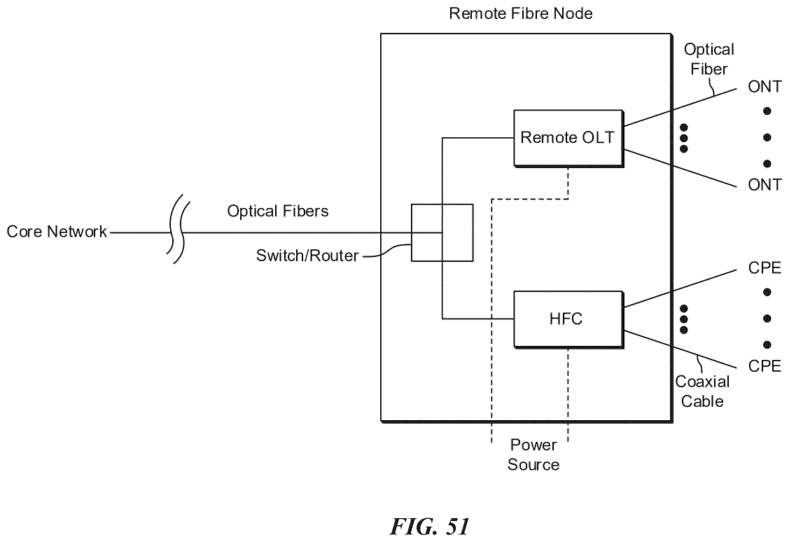

FIG. 49 illustrates a remote OLT.

FIG. 50 illustrates an exemplary network that includes both CMTS and PON.

FIG. 51 illustrates an exemplary node that includes both CMTS and PON.

### DETAILED DESCRIPTION

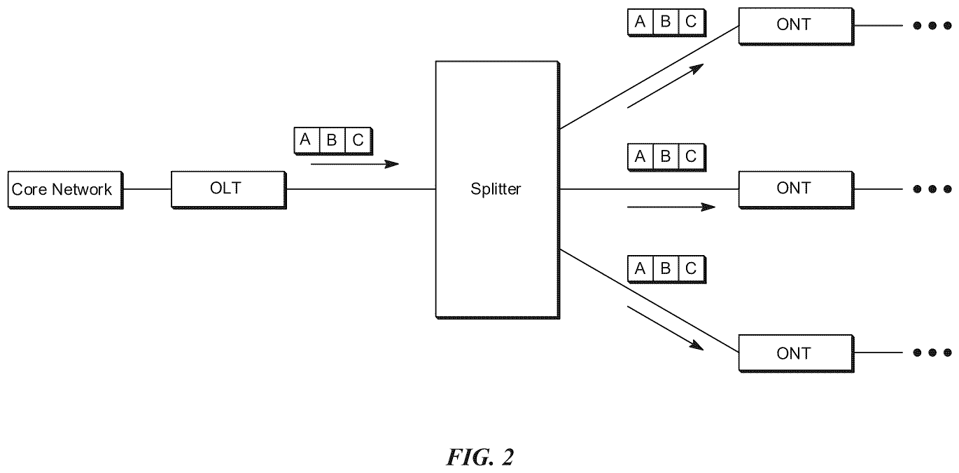

Referring to FIG. 2, the PON network is based upon a point to multi-point downstream transmission arrangement. The data from the OLT is transmitted to all of the ONTs that are interconnected thereto. The data from the OLT is transmitted in the form of one or more frames, where each frame includes data for one or more of the ONTs. For example, in GPON a constant of 125 μs frame is used, where each frame includes (among other control information) an allocation map which informs on the slots granted to allocation ids. Accordingly, each frame is broken up into one or more timeslots that are designated for a corresponding selected one of the ONTs.

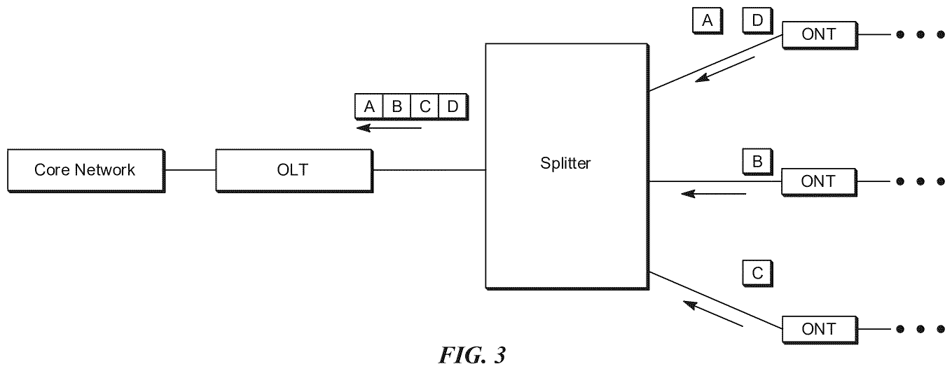

Referring to FIG. 3, the PON network is based upon a multi-point to point upstream transmission arrangement using a time divisional multiple access mechanism. The OLT assigns timeslots (BWmaps) for each ONT to transmit its upstream transmission to ensure a collision free transmission. The data from each of the ONTs is transmitted to the corresponding OLT that it is interconnected thereto. The data from the ONT is transmitted in the form of a portion of one or more frames, where each frame includes data for one or more of the ONTs. For example, in GPON a reference frame of 125 μs frame is used, which is not an absolute value since a round of allocations may span through multiple upstream frames. GPON uses a Generic Encapsulation Method (GEM), which allows for the transport, segmentation and reassembly of Ethernet frames and legacy traffic (ATM or TDM). Accordingly, each frame is broken up into one or more timeslots that are designated for a corresponding selected one of the ONTs.

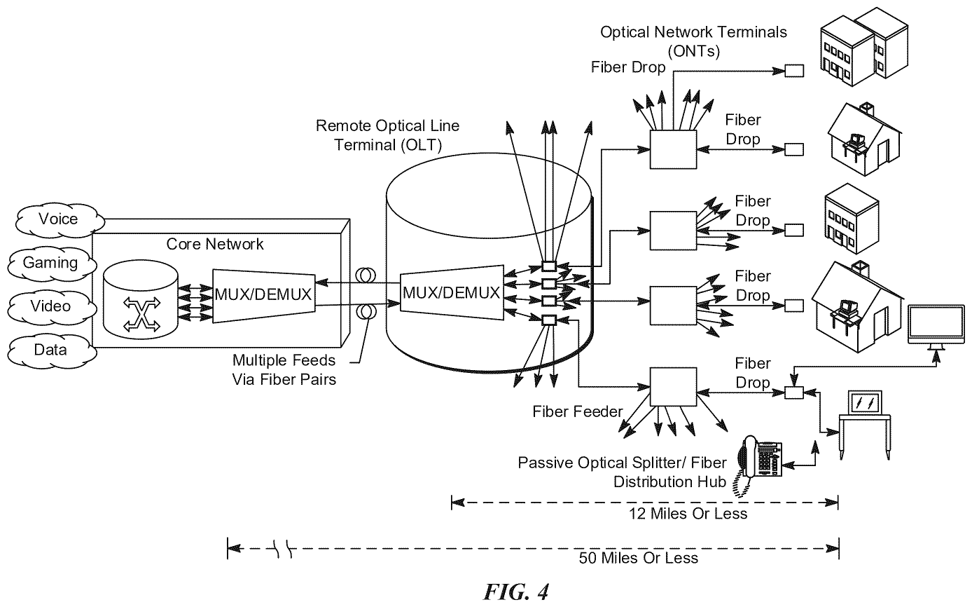

Referring to FIG. 4, it is often desirable in some installations to locate the optical line terminal at a location remote from the core network, generally referred to as a remote optical line terminal (OLT). The remote OLT may include one or more feeds from the core network to the remote OLT. The remote OLT may then distribute data to a plurality of ONTs and receive data from the plurality of ONTs. Each of the ONTs in turn provides data to and receives data from customer devices. The remote OLT typically has the capability of providing services to a few hundred to a few thousand ONTs.

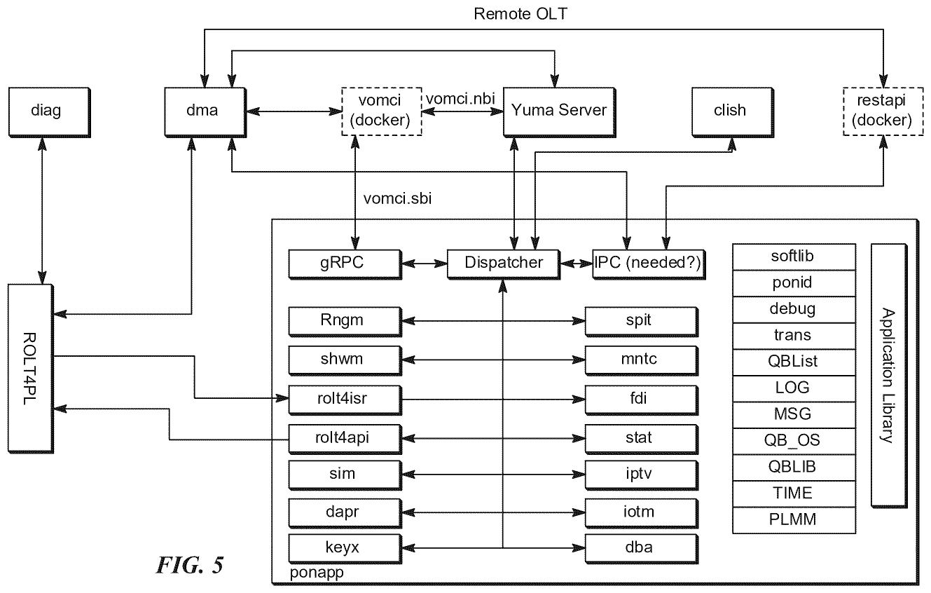

Referring to FIG. 5, an exemplary OLT, which may include a local or a remote OLT, is illustrated. By way of example, a diag process, a dma process, a clish process, a restapi process, a gRPC process, a rolt4isr process, and/or a rolt4api process are preferably included locally on the OLT. Also, a dynamic bandwidth allocation process which allocates available bandwidth among to each of the ONTs is likewise included locally on the OLT. Other processes associated with the remote OLT, such as the vomci and/or Yuma server may be virtualized and located on a cloud based server. For example, the VOMCI may (1) receive service configurations from a virtual OLT management function, (2) translate the received configurations into ITU G.988 OMCI management entities and formatting them into OMCI messages, (3) encapsulating and sending formatted OMCI messages to and from a VOMCI proxy, (4) translating the OMCI messages (presenting ONT's operational data) received from the vOMCI proxy into data (e.g., notifications acknowledges, alarms, PM registers) understandable by the vOLT management function, and/or (5) sending the above ONT operational data to the vOLT management function. See, TR-451 vOMCI Specification, June 2022 and ONT management and control interface (OMCI) specification, G.988, November 2017, both of which are incorporated by reference herein in their entirety. See, TR-385 ITU-T PON YANG Modules, October 2020, incorporated by reference herein in its entirety. See, TR-383 Common YANG Modules for Access Networks, March 2022, incorporated by reference herein in its entirety.

By way of example, the gRPC provides gRPC server and client layer to interface with multiple vomci agents which may be providing vomci services to the ROLT.

By way of example, the dispatcher provides a messaging pathway between components within the ponapp. Local microservices may register callbacks for message ids which is part of the MSG layer. Any microservice can route to another based on the top 2 bytes of a message id that indicates the destination.

By way of example, the IPC provides TCP and UDP sockets for relaying messages to and from the application in the MSG lib format, and works side by side with the dispatcher.

By way of example, the mgm is a ranging manager that provides the state machine and local for the physical layer management of the ONT. This includes an auto discovery process, the ranging of an ONT, drift management, and LOS handling.

By way of example, the shwm is a shelf manager task that handles any devices that are outside of the rolt4api/rolt4isr domain.

By way of example, the rolt4isr is a handler for incoming interrupts from the PL.

By way of example, the rolt4api handles requests from various microservices in the ponapp to program or interact with the ROLT.

By way of example, the sim provides simulations services to provide the ability to simulate devices that may not be physically present.

By way of example, the spit is a smartcard proxy interface task that provides server for application requests coming in or out of the ponapp. A typical path would be from an outside client via IPC via dispatcher into the spit. The SPIT may then relay to other microservices to perform the requested task. Some provisioning may go via the softlib DB and will be further relayed as a provisioning callout.

By way of example, the mntc is a maintenance state machine which is preferably an event drive state machine for ONTs.

By way of example, the fdi is a fault detection and isolation task as a hierarchical alarm tree service to track alarm conditions for different equipment types.

By way of example, the stat is a statistics manager that handles polling of on board statistics and aggregation of statistics for other calling functions.

By way of example, the iptv provides IPTV services, including IGMP snooping/proxy support.

By way of example, the dapr is a destination address programmer that handles unknown upstream source mac addresses for N:1 connections. This may maintain the mac forwarding table in the PL as well as pruning out aged mac addresses.

By way of example, the iotm is an IOT (aka ONT) manager that suppors directives for the ONT.

By way of example, the dba is a dynamic bandwidth allocation.

By way of example, the keyx is a key exchange task that handles key exchanging for ONTs.

By way of example, the softlib is a soft DB library implemented as a memory based database used to contain configurations of the ROLT.

By way of example, the ponid is a library used to associate ITUT serial numbers with ONT ids and/or channel assignment.

By way of example, the debug is a debug library.

By way of example, the trans is a transaction library used for transactional and state based requests for microservices.

By way of example, the QBList is a library of various list and vector functions.

By way of example, the LOG is an event log.

By way of example, the MSG is a message library.

By way of example, the QB_OS is an operating system library.

By way of example, the QBLIB is a library for local APIs.

By way of example, the TIME is a timer library used for time based callback logic.

By way of example, the PLMM is a ploam message library used for the encoding and decoding of ploam messages on the pon.

The core network and/or the optical line terminals provides management and control functionality over the ONT by using an optical network unit management and control interface (OMCI). The core network 200 and the OLT 210 with which it provides data to and receives data from, transmits data and receives data using a PON protocol over an optical distribution network (e.g., optical splitters, etc.) 220. The OLT 210 passes data through the optical distribution network (ODN) 220 to the ONTs 230, and receives data through the optical distribution network (ODN) 220 from the ONTs 230. The OMCI messages between the ONT 210 and the ONUs 230 for management and control are likewise provided between the OLT 210 and the ONTs 230 through the ODN 22. The ONTs 230 provides access network line termination, a user network interface line termination for subscriber devices, and service multiplexing and de-multiplexing for subscriber devices.

The configuration management provides functions to identify the ONTs capabilities and to exercise control over the ONTs. The areas of management for the ONTs include configuration of, (1) equipment, (2) passive optical network and reach extender protection, (3) the user network interfaces, (4) Gigabit-capable passive optical network Encapsulation Method port network contention termination points; (5) interworking termination points; (6) operations, administration, and maintenance flows, (7) physical ports, (8) Gigabit-capable passive optical network Encapsulation Method adaptation layer profiles, (9) service profiles, (10) traffic descriptors, and (11) asynchronous transfer mode adaptation layer profiles. As modelled by the OMCI, the ONT detects and reports equipment, software, and interface failures and declares the corresponding alarms. The ONTs may be considered as managed entities by the exchange of information between the OLT and the ONT, based upon the OMCI messages for optical access networks.

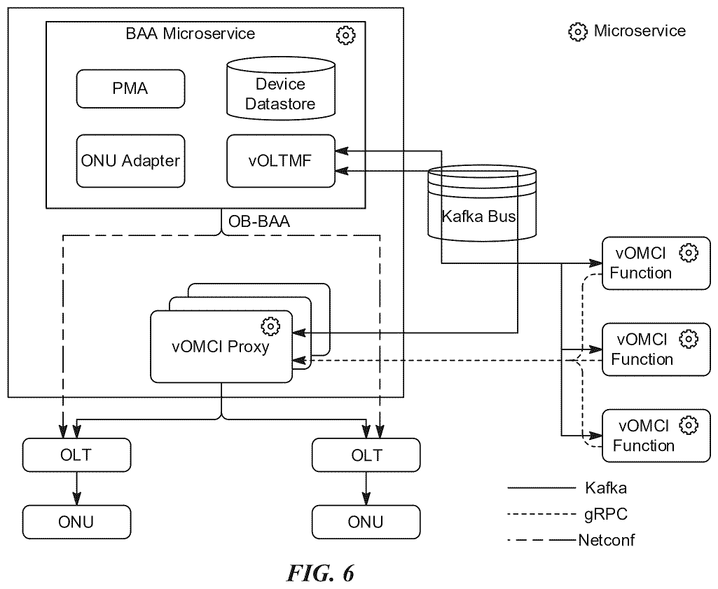

Referring to FIG. 6, a high-level design of a vOLT Management Function (vOLTMF) that may be used to manage ONTs through vOMCI messages is illustrated. There is communication between the vOLTMF, vOMCI Proxy, and vOMCI function based upon creating and deleting ONTs, receiving ont-state-change notifications, and sending requests to ONTs. The vOLTMF manages ONTs through a ONT adapter that may be deployed as broadband access abstraction, the association of which is based on the model, type, vendor, and version mentioned while creating the ONT. The ONT adapter may use a library of the YANG modules for ONTs that the vOLTMF refers to for handling ONT requests, responses, and notifications from external management systems.

The vOLTMF performs actions upon receiving notifications and requests either from an OLT device or other components within the broadband access abstraction core. For example, the onu-state-change notification that is sent by the OLT device on its Northbound Interface (NBI) that is received by broadband access abstraction core. The broadband access abstraction core propagates the notification towards vOLTMF and broadband access abstraction NBI so that it can be handled by the Access SDN M&C.

Upon reception of the notification, the vOLTMF processes the notification, checks if a preconfigured ONU device exists and authenticates the ONU, the vOLTMF transforms the notification to Google Protobufs (GPB) format and propagates the set-onu-communication Action towards the vOMCI function and vOMCI-proxy via the Kafka bus.

All the YANG requests are sent towards the vOMCI function and vOMCI Proxy via the Kafka bus in GPB format. Once the vOMCI function/Proxy processes the requests, the vOMCI function sends the notification/request response in GPB format back to the vOLTMF via the Kafka bus and the response is received through the KafkaNotificationCallback#onNotification( ).

Upon receiving the response, the vOLTMF is responsible for processing the response and performs actions accordingly.

There could be multiple interactions between the vOLTMF and the vOMCI function including parallel configuration requests/commands for either the same or different ONUs. These interactions are parallel and asynchronous such that the requests are not idle/blocked while waiting for responses because the vOLTMF has separate task queues and threadpools to handle the request/response interactions. The following shows the list of vOLTMF threadpools that spawned as new Runnable tasks, namely, processNotificationRequestPool, kafkaCommunicationPool, kafkaPollingPool, processNotificationResponsePool, and processRequestResponsePool. processNotificationRequestPool is used for processing the mediated device event listener callbacks and device notification requests. kafkaCommunicationPool is used to proess individual GET/COPY-CONFIG/EDIT-CONFIG requests inside a MediatedDeviceNetconfSession spawned by preocessRequestResponsePool. kafkaPollingPool is used to tart up the KafkaConsumer implementation and polling for responses from vOMCI-function/vOMCI Proxy. processRequestResponsePool is used for processing notification responses from the vOMCI-function/vOMCI Proxy. The processRequestResponsePool is used for processing GET/COPY-CONFIG/EDIT-CONFIG requests and responses from the vOMCI-function/vOMCI Proxy. In general, the process may be considered a type of protocol adapter to one that operates on an ONT that also works with an OLT in a PON environment. As it may be observed, the manner in which the processing is performed is relatively complex, including Google Protobufs, remote procedure calls, and other complications that require a substantial amount of computational resources to process all the microservices which are burdensome for the OLT.

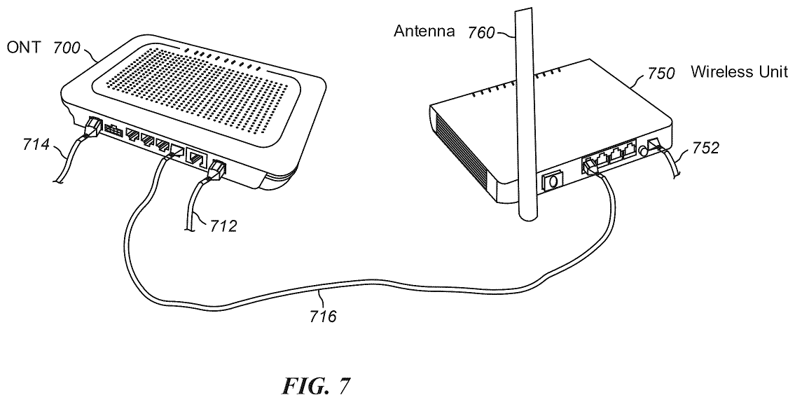

Referring to FIG. 7, an optical network terminal 700 receives passive optical network framed data on an optical fiber 712. The optical network terminal 700 includes a power connector 714 to provide wall power for the operation of the optical network terminal 700. It desirable that the optical network terminal 700 includes output data 716 in the form of Ethernet based data that is provided to and receives input data from a wireless unit 750. The wireless unit 750 includes output data 716 in the form of Ethernet based data is provided to and receives input data from the ONT 700. The wireless unit 750 includes a power connector 752 to provide wall power for the operation of the wireless unit 750. The wireless unit in turn transmits data to and receives data from an associated antenna 760 that is interconnected thereto. In this manner, the passive optical network may exchange data that is received from wireless unit/antenna from a customer and wirelessly transmitted to a customer from the wireless unit/antenna. While such a combination is useful for the wireless transmission of data and wireless receiving of data in a residential environment it is not especially suitable for being used in an outdoor environment, such as a series of wireless transmitters installed on telephone poles along a road to provide wireless service to a neighborhood.

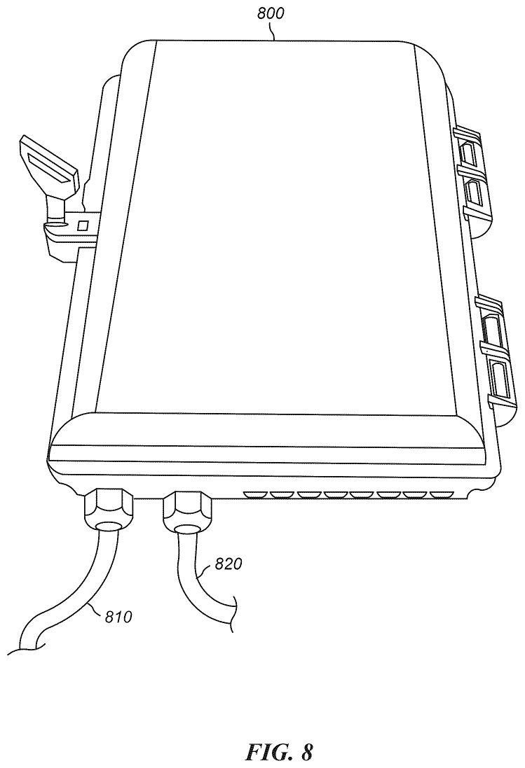

Referring to FIG. 8, an optical network terminal 800 may include a weatherproof housing that includes a hinged clam shell that is secured on the opposing side to form a waterproof seal from the rain and humidity. The optical network terminal 800 may include an interconnected optical fiber 810 passing through a first opening in the housing for passive optical network based signaling. The optical network terminal 800 may include an Ethernet cable 820 passing through a second opening in the housing for Ethernet based signaling. The optical network terminal 800 may include, but preferably does not include an external power connector to receive wall power for the operation of the optical network terminal 800. Rather than wall power, the optical network terminal 800 preferably receives its operational power through the optical fiber 810. With the electrical power being provided through the optical fiber the optical network terminal 800 is suitable for being located at remote locations, such as on a telephone pole, a wall, or a stringer between telephone poles, where electrical power may not be readily available.

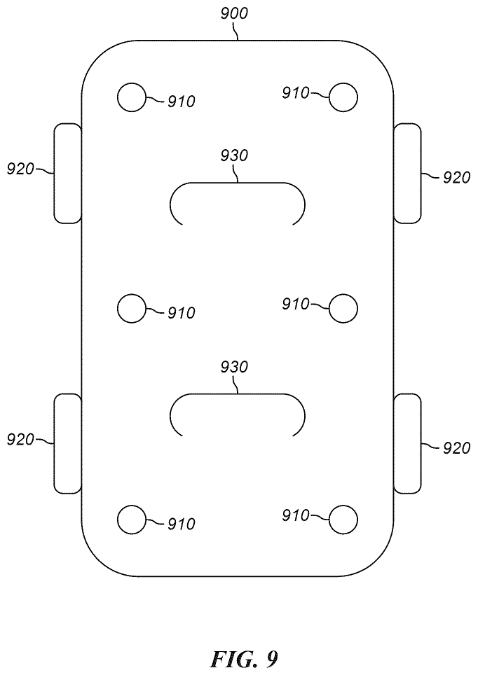

Referring to FIG. 9, a plate 900 may be detachably interconnected to the reverse side of the optical network terminal 800. The plate 900 may include a set of holes 910 so that the plate 900 may be secured to a wall or a telephone pole with a set of screws, and the optical network terminal 800 secured to the plate 900. The plate 900 may also include a set of loops 920 on the sides thereof that are suitable for a set of straps to be attached thereto and looped around a telephone pole or other structure to secure the plate 900 to a telephone pole or otherwise, and the optical network terminal 800 secured to the plate 900. The plate may include a set of loops 930 so that the plate 900 may be secured to a stringer (e.g., a wire between a pair of telephone poles), and the optical network terminal 800 secured to the plate 900. In this manner, the optical network terminal 800 is suitable for attachment to a vertical surface, a telephone pole, and/or a stringer.

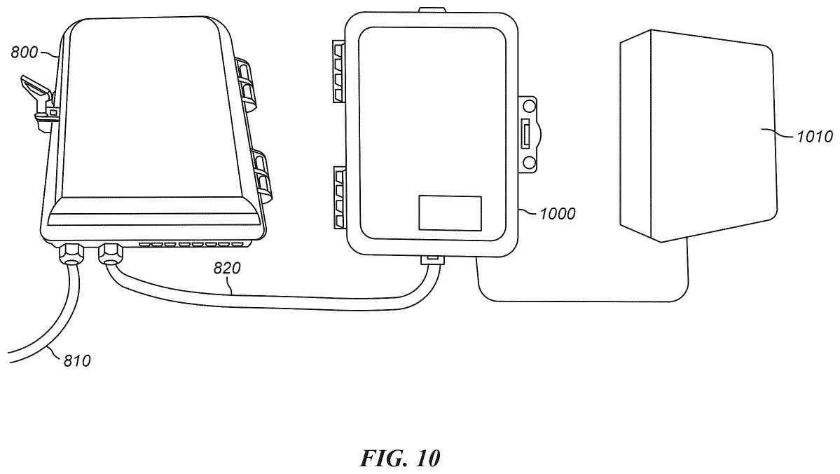

Referring to FIG. 10, often the installer for an optical network terminal 800 for a passive optical network at an exterior location, such as a telephone pole, uses trained technicians for optical networks. However, often the installer for wireless networking-based components at an exterior location, such as a telephone pole, uses a different set of trained technicians for wireless networking. With the trained technicians used for the installation and configuration of the optical network terminal 800 being different than for wireless networking, it is desirable that the demarcation of the two components of the architecture is configured in a suitable manner. A wireless unit 1000 is preferably included within a sealed housing

A wireless unit 1000 preferably includes a weatherproof housing and a single port for the Ethernet cable 820 so that Ethernet based data may be exchanged between the optical network terminal 800 and the wireless unit 1000. The wireless unit 1000 may include, but preferably does not include an external power connector to receive wall power for the operation of the wireless unit 1000. Rather than wall power, the wireless unit 1000 preferably receives its operational power through the Ethernet cable 820. With the electrical power being provided through the Ethernet cable 820 the wireless unit 1000 is suitable for being located at remote locations, such as on a telephone pole, a wall, or a stringer between telephone poles, where electrical power may not be readily available. In this manner, the optical network terminal 800 receives its power from the optical fiber 810 and the wireless unit 1000 receives its power from the optical network terminal 800 from the Ethernet cable 820. The wireless unit 1000 may include a plate for interconnection to a suitable structure. Also, by receiving its power from the Ethernet cable 820, the wireless unit 1000 is not directly interconnected to the power source of the optical network terminal 800 which may otherwise adversely impact the power levels of the optical network terminal. The wireless unit 1000 may include an integrated antenna for the transmission of wireless signals and for receiving wireless signals. While an integrated antenna may be used, such antennas tend to be directional in nature and may require particular orientation of the wireless unit 1000 for effective transmission to the customer which may not be readily feasible. An antenna 1010, which is preferably a directional antenna, is included within a weatherproof enclosure, and is electrically interconnected to the wireless unit 1000. The antenna 1010 may include a plate or otherwise to secure it to a suitable structure. In this manner, the antenna 1010 may be directionally oriented in a suitable direction, independently of the wireless unit 1000 and the optical network terminal 800.

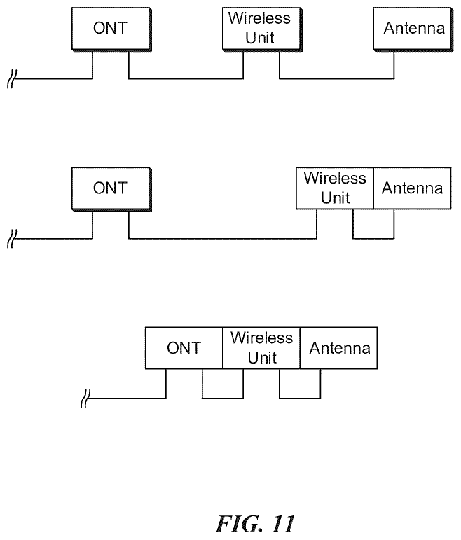

Referring to FIG. 11, the optical network terminal, the wireless unit, and/or the antenna may be detachably attached to one another with a suitable attachment. For example, the optical network terminal, the wireless unit, and the antenna may be interconnected together with one another using flexible interconnections to transport data. For example, the optical network terminal, the wireless unit, and the antenna may be interconnected together with one another using flexible interconnections to transport data, where the wireless unit and the antenna are interconnected together. For example, the optical network terminal, the wireless unit, and the antenna may be interconnected together with one another using flexible interconnections to transport data, where the optical network terminal, the wireless unit, and the antenna are interconnected together.

When the interconnection between the optical network terminal and the wireless unit use particular spectrums, such as licensed 4G and/or 5G spectrum, the Ethernet connection may be replaced by a common public radio interface or an enhanced common public radio interface which is a serial interface. Electrical power may be provided over the common public radio interface.

Depending in the network architecture, there may be multiple wireless units interconnected to a single optical network terminal. Further, there may be multiple antennas interconnected to a single wireless unit. In this manner, there is added flexible in architecture to meet particular needs.

Preferably, the optical network terminal and/or wireless unit and/or antenna include a coiled cable (or otherwise) management system so that the interconnections can be extended as far as required, while maintaining the remaining cable within the enclosure in a controlled manner.

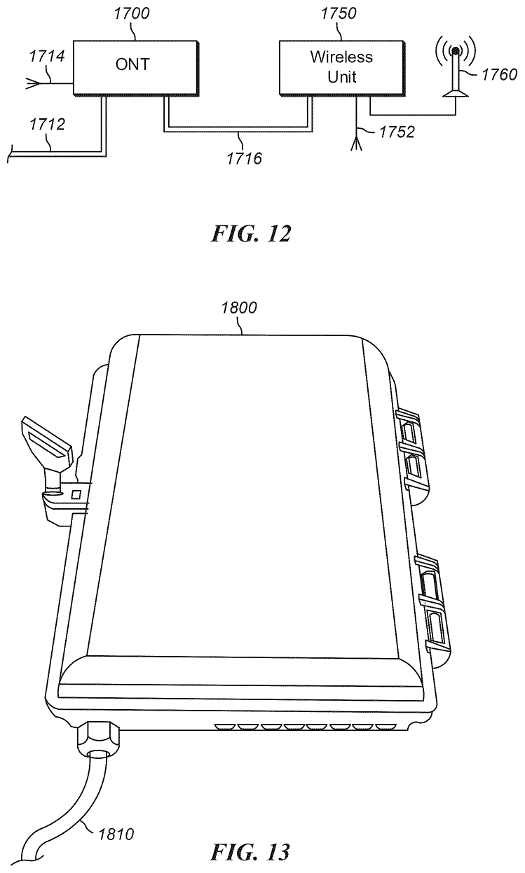

¹Referring to FIG. 12, in some cases, it is desirable to include an optical network terminal together with a wireless transmitter/receiver (e.g., transducer) to provide network based access to a geographic region. By way of example, the optical network terminal 1700 receives passive optical network framed data on an optical fiber 1712. The optical network terminal 1700 includes a power connector 1714 to provide wall power for the operation of the optical network terminal 1700. It desirable that the optical network terminal 1700 includes output data 1716 in the form of Ethernet based data that is provided to and receives input data from a wireless unit 1750. The wireless unit 1750 includes output data 1716 in the form of Ethernet based data is provided to and receives input data from the ONT 1700. The wireless unit 1750 includes a power connector 1752 to provide wall power for the operation of the wireless unit 1750. The wireless unit in turn transmits data to and receives data from an associated antenna 1760 that is interconnected thereto. In this manner, the passive optical network may exchange data that is received from the wireless unit/antenna from a customer and wirelessly transmitted to a customer from the wireless unit/antenna. While such a combination is useful for the wireless transmission of data and wireless receiving of data in a residential environment it is not especially suitable for being used in an outdoor environment, such as a series of wireless transmitters installed on telephone poles along a road to provide wireless service to a neighborhood. ¹ 6043 Specification Red

Referring to FIG. 13, an optical network terminal, a wireless unit, and/or an antenna may be included within a weatherproof housing 1800 that includes a hinged clam shell that is secured on the opposing side to form a waterproof seal from the rain and humidity. The optical network terminal may include an interconnected optical fiber 1810 passing through a first opening in the housing 1800 for passive optical network based signaling. The optical network terminal may include, but preferably does not include an external power connector to receive wall power for the operation of the optical network terminal. Rather than wall power, the optical network terminal preferably receives its operational power through a conductor included with the optical fiber 1810. With the electrical power being provided through the optical fiber the optical network terminal is suitable for being located at remote locations, such as on a telephone pole, a wall, or a stringer between telephone poles, where electrical power may not be readily available.

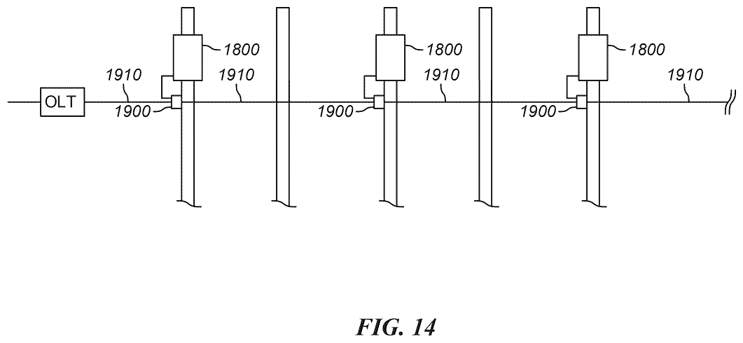

Referring to FIG. 14, when building out a passive optical network-based system, it may be desirable to include a relatively sparse set of weatherproof housings 1800 that include the optical network terminal, the wireless unit, and/or the antenna to provide service to a portion of a neighborhood. The housings may be interconnected to various telephone poles, buildings, or otherwise. The wireless unit and/or antenna may use non-licensed spectrum (such as 2.4 GHz or 5 GHz) or may use licensed spectrum (such as 4G or 5G). An OLT 1920 may be interconnected to an optical fiber 1910 that is interconnected to a set of taps/splitters 1900, each of which are interconnected to a corresponding weatherproof housing 1800. However, to increase the density of the optical network-based system additional weatherproof housings 1800 that include the optical network terminal, the wireless unit, and/or the antenna may be interconnected to intervening telephone poles or otherwise. To add such a weatherproof housing 1800, the optical fiber is cut, the ends of the optical fiber are connectorized, a tap/splitter is installed, the connectorized optical fiber is interconnected with the tap/splitter, a weatherproof housing is installed, and the weatherproof housing (including electronics therein) is interconnected to the new tap/splitter with an optical based interconnection. The new interconnections to the tap/splitter need to be properly made so that the downstream and upstream optical fibers are properly connected. Further, while the installation is being performed, the downstream customers will be without service, which may take a substantial amount of time. Also, the selection of the tap/splitter values for providing optical power to the weatherproof housing needs to be selected appropriately, or otherwise other customers further down the optical fiber may not have sufficient power for their operation. It is noted that the ONT and/or the wireless unit and/or the antenna may be in a single housing, two housings, or three housings, as desired.

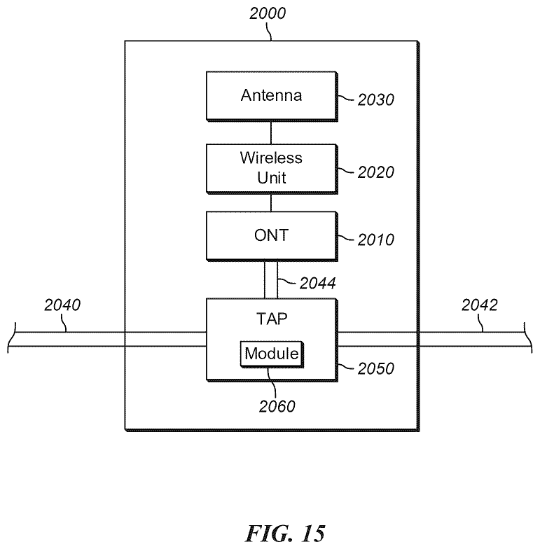

Referring to FIG. 15, it was determined that rather than a “limb” with “branches” architecture for distributing a set of weatherproof housings 2000 with an ONT 2010, a wireless unit 2020, and an antenna 2030, included therein, it is desirable to interconnect the weatherproof housings 2000 (e.g., housing) together in more of a daisy chained manner. A pair of optical fibers 2040, 2042 may be interconnected to the housing 2000, and preferably interconnected to an internal tap (e.g., tap/splitter) 2050. The internal tap 2050 splits off sufficient power to provide the optical signal on an optical fiber 2044 to the ONT 2010. Power may be provided together with the optical fiber, such as a power conductor bundled together with the optical fiber. The value of the internal tap 2050 may be determined, as desired. The tap 2050 preferably includes a detachably engageable module 2060 that determines the value of the split (e.g., 5%, 10%, 15%). In general, a splitter is considered an equal splitting of the optical signal while a tap is an asymmetric splitting of the optical signal. In this manner, a single housing 2000 may be used where the interconnection from the tap 2050 to the ONT 2010 does not need to be disconnected/reconnected when the value provided by the tap is modified.

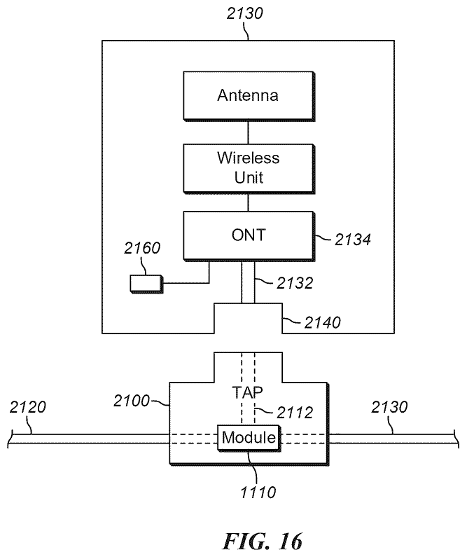

Referring to FIG. 16, a modified architecture includes a tap 2100 that may include a detachably engageable module 2110 that determines the value of the split (e.g., 5%, 10%, 15%). A pair of optical fibers 2120, 2122 may be interconnected to the tap (e.g., tap/splitter) 2100. As an initial installation, the detachably engageable module 2110 may be set to substantially 0% so that substantially all the signal passes through. In this manner, the tap 2100 provides an interconnection of the pair of optical fibers 2120, 2122, without meaningfully degrading the signal. If desired, a dense set of potential locations for a housing (including electronics therein) may be selected by including a tap at each of the locations, such as telephone poles.

A corresponding housing 2130 defines an opening 2140 that detachably engages with the tap 2100. Preferably, an optical fiber 2112 for the tap remains in a pre-installed location and detachably interconnects with an optical fiber 2132 of the housing 2130. In this manner, the interconnection between the tap 2100 and an ONT 2134 is formed by detachably engaging the tap 2100 with the opening 2140 of the housing 2130. If desired, the value of any particular tap 2100 may be fixed, preferably selected based upon a design plan for the passive optical network. In the event that the tap is not interconnected to a housing 2130, the value of the tap is selected such that the downstream devices receive the necessary optical power. The resulting structure includes a pair of external ports, namely an input port and a through port.

The taps are directional in nature, such that the downstream and upstream power levels are typically different. In such a case, the downstream connection needs to be made to the proper port of the tap that is going to be providing downstream interconnections and the upstream connection needs to be made to the proper port of the tap that is going to be providing upstream interconnections. With loops of optical fiber often being included at the interconnection location, one loop from a “downstream” direction and one loop from an “upstream” direction, it becomes increasingly difficult to select proper optical fiber for the interconnection to the particular port of the tap. In addition, the tap may be configured such that the tap may be inserted in a first orientation and may be inserted in a second orientation 180 degrees with respect to the first orientation. In this manner, the tap may be inserted such that the downstream optical fiber and upstream optical fiber may be in either orientation, depending on the manner that the tap is inserted.

One technique for determining if the optical fibers are connected to the proper ports of the tap is to include a light 2160 or other visual indicator on the housing 2130. The ONT 2134 or otherwise any device within the housing determines that it is receiving suitable optical power therefore illumining the light 2160, at least temporarily, indicating the tap 2100 is installed in with the proper orientation.

A system may by generally installed, in relevant part, in the following manner. The system is designed with a fully populated set of housings and tap values that may be installed in the future. The technicians install a set of connectorized optical fibers between each of the locations of the populated set of housing. A set of taps are installed at each of the connectorized optical fiber locations with either a substantially zero tap value or a tap value based upon the system design. A set of housings, together with the ONT, wireless module, and antenna, are installed as needed to provide service to customers. The orientation of the taps or otherwise the connections to the taps may be modified to provide proper directional orientation for the signals.

Depending in the network architecture, there may be multiple wireless units interconnected to a single optical network terminal. Further, there may be multiple antennas interconnected to a single wireless unit. In this manner, there is added flexible in architecture to meet particular needs.

Preferably, the optical network terminal and/or wireless unit and/or antenna include a coiled cable (or otherwise) management system so that the interconnections can be extended as far as required, while maintaining the remaining cable within the enclosure in a controlled manner.

²Another device that may be used within an access network is a fiber link module. In essence, the fiber link module resides outside the plant network between the optical line terminal and the PON optical splitter. The fiber link module enables the use of WDM optics to combine multiple PON servicing groups onto a single fiber. By combing increased reach, increased OLT port utilization, the PON density per fiber, the operator is able to leverage more of its current infrastructure to reduce capital investment. The fiber link module splits the PON network into two different optical links, the optical trunk link and the optical distribution network. The optical trunk link includes the optical link between the OLT and the fiber link module and the optical distribution network includes the optical link between the fiber link module and the ONTs, including optical splitter(s), tap(s), etc. The fiber link module allows selectable pluggable optics in the trunk link, which provides flexibility in wavelength selection as well as link distance. ² 6141 Specification Orange

The deployment of an access network involves the installation of a substantial amount of fiber optical cable(s), splitter(s), tap(s), remote fiber node(s), fiber link module(s), optical drops to the customer(s), and optical network terminal(s). The deployment of the access network is time consuming, expensive, and difficult to trouble shoot that all of the components are properly installed and not faulty. Further, a substantial effort goes into the design of the access network.

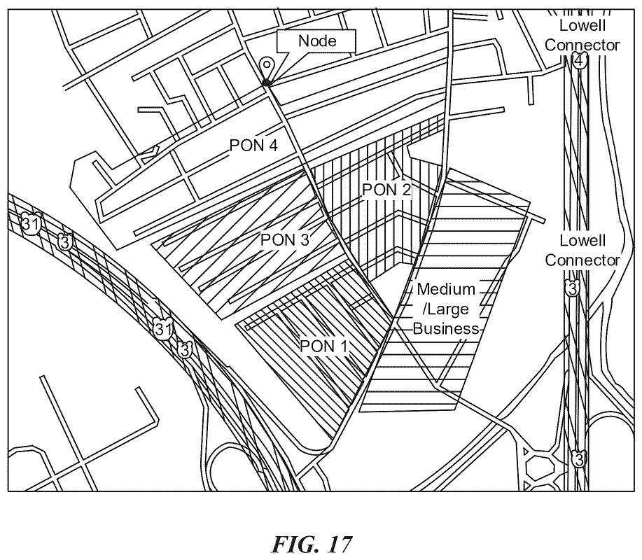

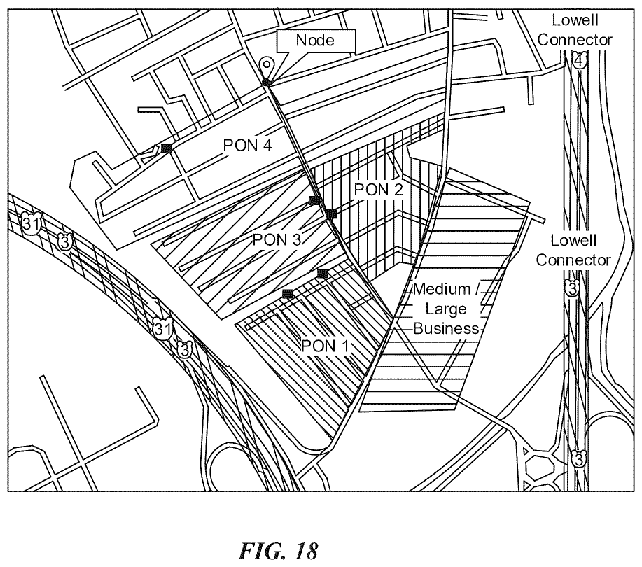

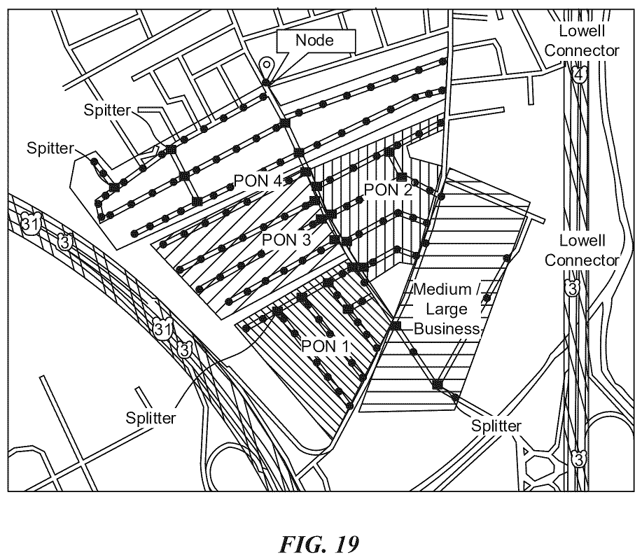

Referring to FIG. 17, an access network may cover a broad geographic region with a variety of different types of customers therein, such as medium business, large business, and residential. In this manner, the access network may be designated within a plurality of different regions that are intended to be served by a respective servicing group, which may be a single port of an OLT and/or a R-OLT. Each of the different regions may be designed in such a manner that they may be operated in an independent manner from the other regions from the node, if desired. However, initially, each of the different regions may be part of a single service group. Referring to FIG. 18, after identifying the different regions to be designated as a respective servicing group a set of one or more nodes may be identified for each of the PON regions. Referring to FIG. 19, after identifying the set of one or more nodes, a set of splitters (designated by a large square) may be designated at appropriate locations. Each of the splitters typically has one input and multiple outputs, each of which may be an equal split (e.g., a 33.33%, 33.33%, 33.33% 3 way split) or unequal split (e.g., a 40%, 40%, 10% 3 way split). Also, the taps for each of the customer (designated by a small square) may be designated at appropriate locations. As an initial matter, each of the different regions may be considered collectively to be a single region and serviced by a single PON port of the node. The operator of the network may then install the various components of the actual network, as needed, when a particular customer is added to the network. For example, a customer may be added, then the operator installs the fiber and various components to provide service to that customer accordingly to the defined network architecture. In this manner, the operator of the network may defer the time and expense for the network construction over time.

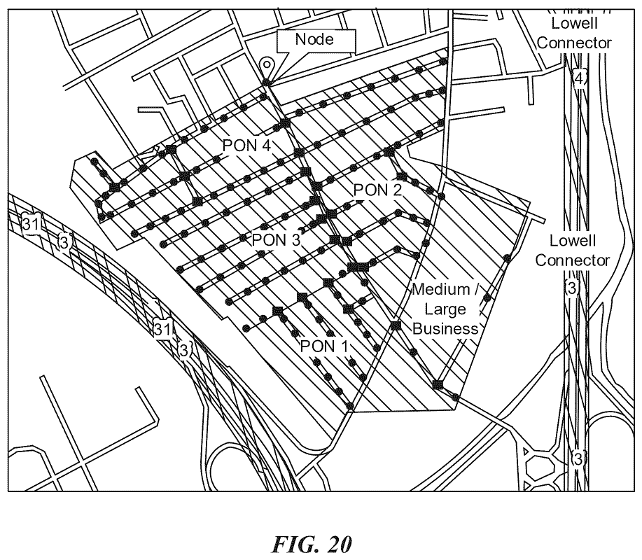

Referring to FIG. 20, if a particular geographic region has sufficient usage, it may be desirable to segregate that geographic region onto a separate PON port of the node. In this manner, the PON 0 geographic region may have its corresponding optical fiber moved from its current PON port of the node to a different PON port of the node so that it may be serviced independent of the other geographic regions. By way of example, the optical fiber may be moved from an output of a splitter at the node to a different PON port of the node. As it may bs observed, multiple “end games” for the PONs can be combined together during initial deployment in order to reduce the number of OLT ports that are initially required. The segmentation may be performed using any suitable technique, such as one or more fiber link module based segmentation and/or feeder network based segmentation.

In many instances, a customer may be added to the access network that is deep in the planned network. To provide service to that customer, a set of one or more splitters may be installed and a set of one or more taps may be installed together with optical fiber, to build out the network according to the planned network architecture to provide service to that customer. In building out the planned network architecture, there may be additional components, such as splitters and/or taps that provide no service to other customers because those portions of the network are yet to be built out, typically as a result of no customers are currently requesting service which would be serviced by such additional components. In this manner, there is inherently additional signal power loss in the network at each of these “non-customer” components in a manner designed to service additional potential customers in the future. However, it may be problematic to test each of these components while they are being installed because there may be no current customers using particular ports of these components (e.g., splitters and/or taps and/or R-OLT and/or FLM).

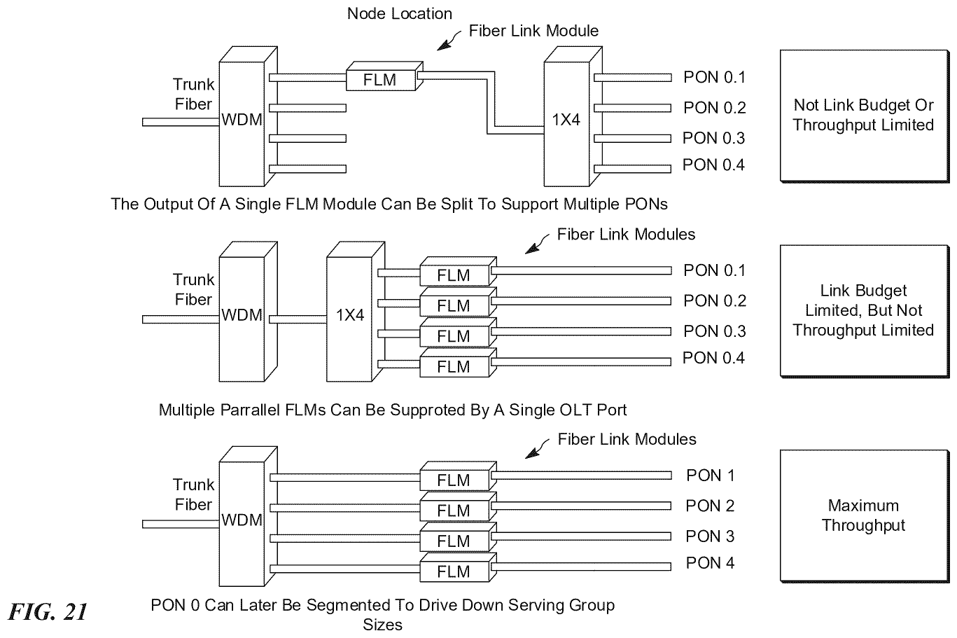

Referring to FIG. 21, fiber link module based segmentation is illustrated. For example, the output of a single FLM module may be split to support multiple PONs. For example, multiple parallel FLM modules may be supported by a single OLT port. For example, PON 0 may be sgementsed to drive down the serving group sizes.

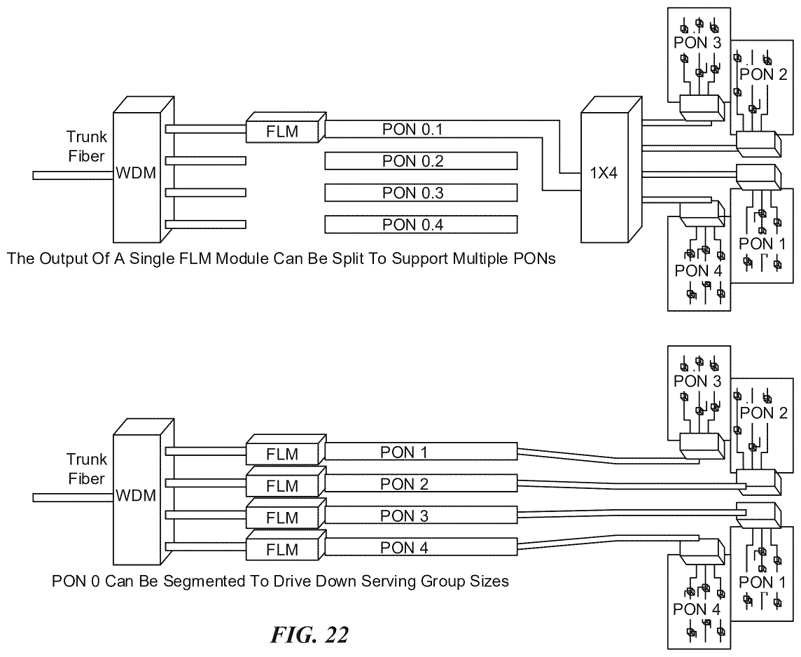

Referring to FIG. 22, feeder network based segmentation is illustrated. For example, the output of a single FLM module may be split to support multiple PONs. For example, PON 0 may be segmented to drive down serving group sizes.

The architecture of the access network may be designed in a graphical tool operating on a computer (e.g., a server, a cloud based computing device, a local computer, or otherwise). The identification of the various components of the access network may likewise be identified in the graphical tool operating on the computer. As the access network is built out as a result of customer's being added to the network, the additional installation of components may be identified in the graphical tool operation on the computer. In this manner, the operator may maintain the current status of the access network, while retaining an ‘end goal’ of the fully built out access network, which is subject to change over time. However, the installation of the network, at least initially, may involve additional redundant fiber lines, splitter(s), tap(s), so that the access network may be segmented over time as additional customers are included, in accordance with the network plan.

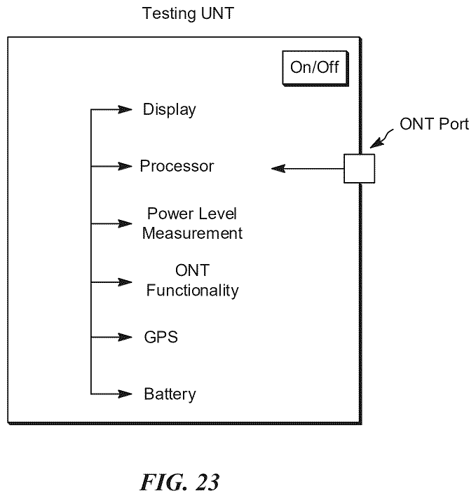

During the building out of the network as additional customers are added to the access network over time, and during maintenance of the existing network (e.g., replacing and/or repairing of components), it is desirable that the technician is able to verify that the various components operate as intended and otherwise are not faulty and/or installed improperly. Referring to FIG. 23, a portable battery powered testing unit is desirable for the technician. The testing unit preferably includes at least a portion of the ONT components therein sufficient to verify the connectivity to a particular connector on the network (e.g., a customer location at the end of a fiber drop, a port of a tap, a port of a splitter, a port of a remote OLT, and/or a port of a fiber link module. The testing unit preferably includes an on/off switch to turn on/off the testing unit, respectively.

The testing unit may be interconnected to an OLT port, a fiber link port, a tap, a splitter, and/or end of a fiber cable, to test its interconnectivity to send and receive PON signals. In this manner, the testing unit is ranged by the OLT, and thereafter sends and receives test based signals at the appropriate time to verify the integrity of the interconnection. The confirmation of the interconnectivity or the lack of the confirmation of the interconnectivity, for particular parts of the access network, may be maintained by the computer for the deployment of the access network so that particular locations within the access network can be confirmed to be operational or otherwise suitably installed for future use.

The testing unit may also sense the power levels of the received optical signal in order to determine its power levels. In this manner, the testing unit may also be used to confirm that the power levels are within a suitable operational range. Also, the power levels from the testing unit may be provided to the computer for the deployment of the access network so that the power levels, as deployed, are maintained by the computer. The computer system and/or the testing unit may use the power levels to confirm that the power levels, as deployed, are suitable for the particular device and it will not negatively impact on other portions of the network in the future. For example, if the power levels at a particular location are to high, the particular ONT may operate properly, but otherwise may not leave sufficient power for the remainder of the devices in the network when additional customers are added or otherwise additional portions of the access network are deployed. For example, the testing unit may be used to test the power levels at each port of a splitter and/or tap.

The testing unit may further include a global positioning system based circuitry so that it may determine its geographic location. Also, the testing unit may use triangulation based techniques, such as triangulation based upon cellular towers, to determines its geographic location. The geographic location, as determined by the testing unit, may be provided to the computer which is associated with any other data being provided. For example, the power levels measurements may include the geographic location where such power level measurements were obtained. For example, the interconnectivity measurements may include the geographic location where such interconnectivity measurements were obtained. In this manner, the access network information maintained by the computer may confirm that the location where a measurement is taken by the technician matches with the anticipated location based upon the access network information maintained by the computer. Any substantial deviations from the as build geographic location and the anticipated geographic location may be automatically determined and flagged by the computer system so that the operator may either update the topology of the access network or otherwise determine the measurement was in error. For example, the technician may have misidentified the location that was being measured. For example, the anticipated access network configuration may not match the as-built access network, which may occur due to unforeseen obstacles. Also, as a result the as-built access network may be used in a suitable manner.

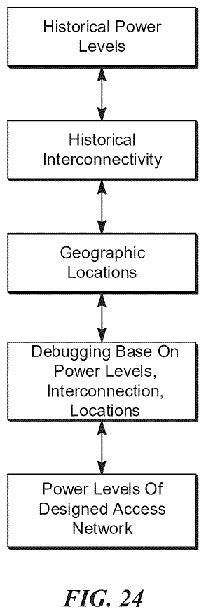

Referring to FIG. 24, for an existing access network, the previously obtained historical set of power levels and/or interconnectivity at various geographic locations may be used to assist in debugging issues that may occur in the access network. The historical data maintained by the computer includes the anticipated power levels and/or interconnectivity, as designed. The historical data maintained by the computer includes one or more power levels measured by the testing unit over time showing the actual measurement values and/or interconnectivity. By using the testing unit to measure the current power levels at any particular location, together with confirmation of its location using geographic location information, a determination by the testing unit and/or computer may be made whether the power levels are as anticipated or otherwise whether the power levels have sufficiently changed in some manner and/or interconnectivity. For example, the power levels may have substantially dropped, which would indicate an issue with the access network. Therefore, with this added information, the technician may check various locations within the access network to determine if the power levels are suitable and/or the interconnectivity. This substantially decreases the time for the technician to determine a likely source of any access network issues.

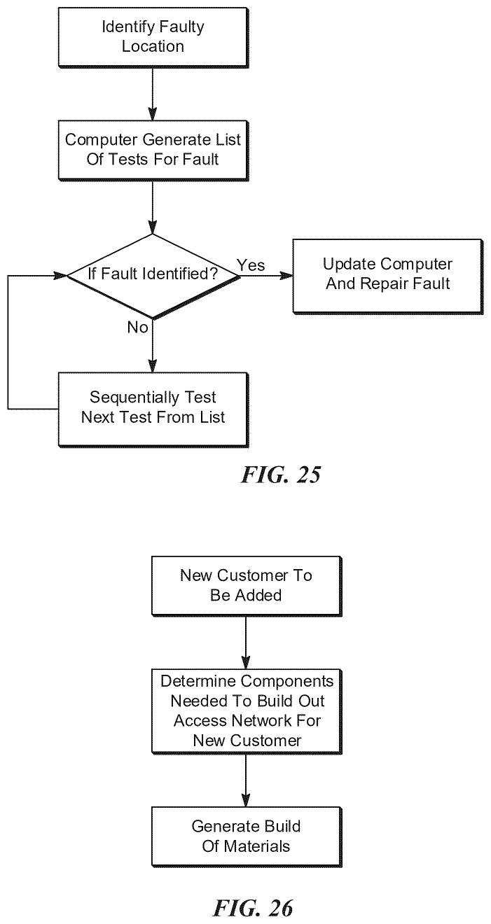

Referring to FIG. 25, if there is an identification location within the access network that the power levels and/or interconnectivity is faulty this information may be provided to the computer. Based upon this faulty location and type (e.g., power level and/or interconnectivity), the computer determines a set of debugging instructions to determine the source of the fault. For example, the computer may identify a set of measurements to be taken (e.g., power level and/or interconnectivity) together with an anticipated result for each measurement to identify the source of the fault. The technician uses the testing unit to perform each of the tests in the order identified until the source of the fault is identified. Upon identifying the source of the fault, the technician may perform a suitable modification to the access network to remedy the fault, the result of which may be updated to the computer for the current state of the access network.

Referring to FIG. 26, when a new customer is to be added to the access network, the computer may determine those portions of the access network that needs to be constructed to provide service to the new customer. The construction may include a set of one or more splitters, a set of one or more particular taps, a set of one or more R-OLTs, a set of one or more FLMs, a set of one or more lengths of optical fiber, a set of one or more connectors, etc. The computer may determine all the request components that are going to be required to provide service in accordance with the network design. The computer may then generate a build of material for the technician, that may be memorized in electronic and/or paper form.

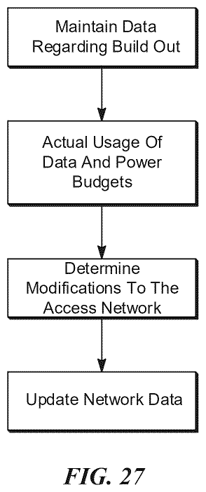

Referring to FIG. 27, as the access network is built out for additional customers over time, the computer maintains information regarding the build out. The computer may also obtain information regarding the actual usage of the access network by the customers and/or power budgets at one or more locations within the access network. Based upon the state of the build out together with actual usage of data capacity and/or power budgets of the access network by the customers, the computer determines when modifications to the existing fiber interconnections in terms of a port that a fiber is interconnected with is made. In this manner, when a portion of the access network is to be supported by its own port of an OLT, by way of example, the computer may indicate the desirability of such a modification to the access network. In addition, the computer may indicate what modifications should be made to perform such a change. After the modification is made, the computer is updated with the newly modified access network.

In another embodiment, each of the components to be installed in the access network because the network if pre-determined may be bar coded (e.g., a QR code) so that upon installation of a component, the testing unit may scan the QR code to identify the type of component, test one or more of the ports of the component, and provide this data to the computer together with geographic information for updating the as built access network. The computer may further verify that the measured data by the testing unit is within anticipated tolerates based upon the as-built access network maintained by the computer. If the measured data is sufficiently different, then the technician may be provided with an indication that the particular component may be faulty.

³In order to provide reliable data communication forward error correction (FEC) is applied on the data frames transmitted by the OLT in the downstream direction and frames transmitted by the ONTs in the upstream direction. The FEC is used for correcting errors in data transmission over unreliable or noisy communication channels. The FEC adds redundancy (parity) data to the transmitted data using a code. Exemplary FEC coding techniques include, for example, Reed-Solomon (RS), Bose and Ray-Chaudhuri (BCH), and low-density parity-check (LDPC) coding. ³ 6145 Specification Green

A 25-Gigabit-capable asymmetric and symmetric passive optical network (25GS-PON) operates over a point to multipoint optical access infrastructure at, for example, a nominal data rate of 25 Gbit/s in the downstream and 25 Gbit/s in the upstream directions. The 25GS-PON preferably uses a low-density parity-check (LDPC) forward error correction coding. The low-density parity check (LDPC) FEC mothercode used for 25GS-PON is based on the mothercode specified by the IEEE P802.3ca. The mothercode is a 12×69 quasi-cyclic matrix with a circulant size of 256. As a result, a codeword is 69×256=17664 bits in size of which payload is 57×256 bits=14592 bits and parity is 12×69 bits=3072 bits. This is then noted as LDPC(17664,14592). The selected LDPC code for 25GS-PON is a non shortened and 2 column (512 bits) punctured code, based on the IEEE 802.3ca task force mothercode. The puncturing is applied from the right side of the matrix. Optionally, interleaving/de-interleaving can be applied following P802.3ca. As a result, the selected code for 25GS-PON is LDPC(17152,14592), which has the following characteristics: codeword length: 17152 bits; payload length: 14592 bits; and parity length: 2560 bits.

In general, the LDPC is a linear error correcting code defined by a sparse parity check matrix. The LDP code typically uses low depth constituent codes (accumulators) in parallel, each of which encode only a small portion of the input frame. The many constituent codes may be viewed as many low depth convolution codes that are connected via the repeat and distribute operations. For the encoding and/or decoding of the LDPC, the process may include an iterative process for processing of the data. As a result of the iterative process, especially in the case of a having a long distance between the OLT and ONUs resulting in degraded signals, and/or using poor quality optical components, or temporarily, e.g., due to construction work in the fiber vicinity, inclement weather conditions, performance degradation due to aging, or physical damage to the ODT optical fiber, the iterative process may require substantially computational resources. While the OLT may be suitable for performing the LDPC based processing, it may require a substantial amount of computational resources that may not be readily available if a substantial amount of data is being continually received by the OLT. This is especially the case if the OLT is also performing other substantial tasks in addition to the iterative decoding process.

Other forward error correction codes may likewise require a substantial amount of computational resources, especially those codes that are based upon an iterative process.

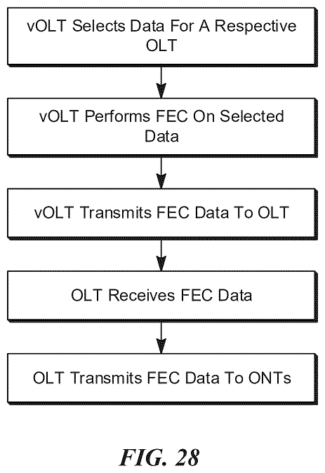

Referring to FIG. 28, the vOLT selects data that is to be provided to a respective OLT. The vOLT, prior to providing the data to the respective OLT, performs a forward error correction processing for encoding by an OLT for the transmission of data to the ONTs is preferably virtualized and provided by the vOLT. The vOLT may be defined as including the respective forward error correction for the OLT. The forward error corrected data is transmitted to the OLT. The OLT receives the forward error corrected data and transmits this data to the corresponding ONTs. The computational resources required for forward error correction by the OLT are reduced.

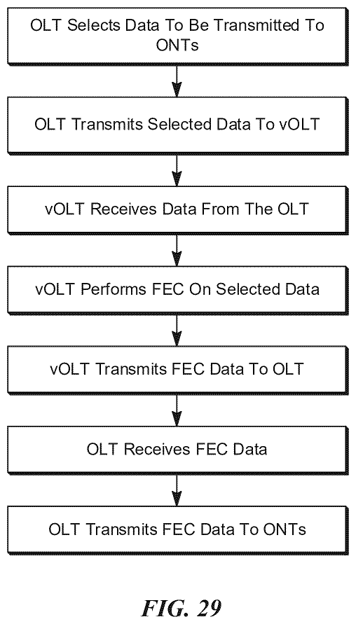

Referring to FIG. 29, in a modified technique, the OLT selects the data based upon its processing that is to be transmitted to the ONTs. The OLT transmits the data that is to be transmitted to the ONTs to the vOLT which receives the data. The vOLT, prior to providing the data back to the respective OLT, performs a forward error correction processing on the received data from the OLT. The forward error corrected data is transmitted by the vOLT to the OLT. The OLT receives the forward error corrected data and transmits this data to the corresponding ONTs. While there is a latency in the transmission of the data to the vOLT and from the vOLT, the computational resources required for forward error correction by the OLT are reduced.

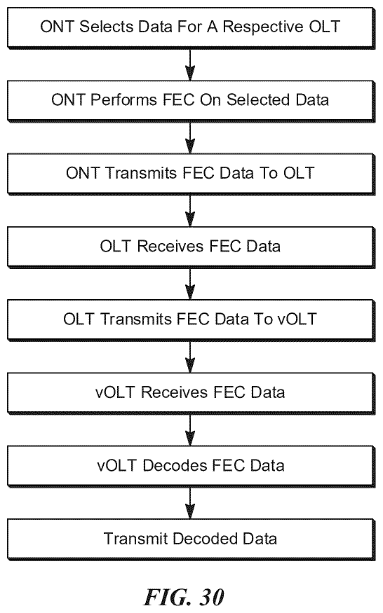

Referring to FIG. 30, the ONT selects the data based upon its processing that is to be transmitted to the respective OLT. The ONT performs forward error correction encoding to the data and provides the forward error corrected data to the OLT. The OLT transmits the received forward error corrected data to the vOLT which receives the forward error corrected data. The vOLT performs a forward error correction decoding processing on the received data from the OLT. The decoded forward error corrected data is the subsequently processed by the core network or otherwise. The computational resources required for forward error correction by the OLT are reduced.

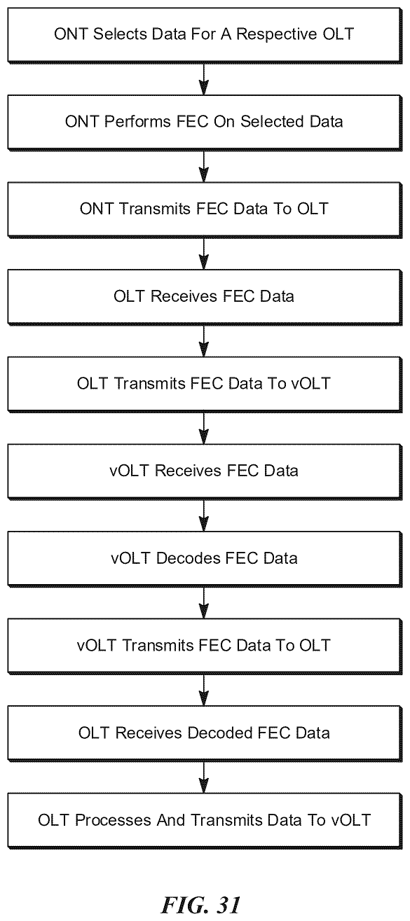

Referring to FIG. 31, in a modified technique, the ONT selects the data based upon its processing that is to be transmitted to the respective OLT. The ONT performs forward error correction to the data and provides the forward error corrected data to the OLT. The OLT transmits the received forward error corrected data to the vOLT which receives the encoded forward error corrected data. The vOLT, prior to providing the data back to the respective OLT, performs a forward error correction decoding on the received data from the OLT. The decoded forward error corrected data is transmitted by the vOLT to the OLT. The OLT receives the decoded forward error corrected data and continues to perform suitable processing on the data in a manner consistent with the OLT having performed the decoding of the forwarded error correction processing. After competing its processing of the data by the OLT, the decoded data may be transmitted to the vOLT. While there is a latency in the transmission of the data to the vOLT and from the vOLT, the computational resources required for forward error correction by the OLT are reduced.

As it may be observed, the upstream transmissions from the ONTs to the OLT are frequency locked but not phase locked. Therefore, there are unknown analog variations in a phase delay on the received signals in the upstream direction from each of the ONTs. Accordingly, it is desirable to align the received signals to the same clock phase for subsequent processing and transmission to the vOLT and/or core network.

With a tree-like network topology for PON, the transmission modes for downstream (e.g., from the optical line termination, (OLT) to optical network terminal (ONT)) and upstream (e.g., from the ONT to the OLT) are different. For the downstream transmission, the OLT broadcasts optical signal to all the ONTs. Each ONT may determine which frame is in the stream by reading the header of the frame. However, in the upstream channel, ONTs cannot transmit optical data signal in such a continuous mode. This difference in transmission is because all the signals transmitted from the ONTs converge (with attenuation) into one fiber to the OLT. To accommodate such a shared optical fiber, a burst mode transmission is used for upstream channel. The given ONT only transmits optical packet when it is allocated a time slot and it needs to transmit, and all the ONTs typically share the upstream channel in the time division multiple access (TDMA) mode. The phases of the burst mode optical packets received by the OLT are different from packet to packet, since the ONTs are not synchronized to transmit optical packet in the same phase, and the distance between OLT and given ONT are different. In order to compensate the phase variation from packet to packet, burst mode clock and data recovery (BM-CDR) may be used by the OLT. Such burst mode clock and data recovery generates a local clock with a frequency and phase the same as the individual received optical packet in a short locking time. The generated local clock can in turn perform correct data decision.

With the nature of the burst clock recovery performing characterization of the received data, the burst clock recovery is preferably maintained and performed by the physical OLT.

The bandwidth management typically involves two principal issues, namely, bandwidth negotiation and bandwidth allocation. Bandwidth negotiation is related to exchanging information between the OLT and each ONT in order for each ONT to report its bandwidth demand to the OLT and for the OLT to send its bandwidth allocation decision to each ONT. See, IEEE 802.3ah, incorporated by reference herein in its entirety. For example, for EPON the bandwidth negotiation includes two 64-bytes MAC control messages: REPORT and GATE. The REPORT message is generated by each ONT to report its queue status to the OLT. The OLT allocates bandwidth for each ONT based on the queue status information contained in the received REPORT messages, and uses the GATE message to deliver its bandwidth allocation decision to each ONT.

The bandwidth allocation allocates bandwidth (or a timeslot) for each ONT that the OLT needs to perform based on the bandwidth requests from each ONT as well as some allocation policy and/or service level agreement. Typically, the bandwidth allocation is based upon either static bandwidth allocation (SBA) or dynamic bandwidth allocation (DBA). The DBA dynamically allocates a variable timeslot to each ONT based on the instantaneous bandwidth demand of the ONTs. In one embodiment, the OLT may dynamically allocate bandwidth for each ONT based upon polling to flexibly arbitrate the transmission of multiple ONTs.

For example, the dynamic bandwidth allocation may employ a resource negotiation process to facilitate queue report and bandwidth allocation. The OLT polls ONTs and grants timeslots to each ONU in a round-robin fashion. The timeslot granted to an ONT is determined by the queue status reported from that ONT. Therefore, the OLT is able to know the dynamic traffic load of each ONT and allocate the upstream bandwidth in accordance with the bandwidth demand of each ONT. Moreover, it also employs the service level agreements of end users to upper bound the allocated bandwidth to each ONT.

For example, the dynamic bandwidth allocation may be based upon an estimation to attempt to reduce the queue length of each ONT and thus the average packet delay by estimating the packets arrived at an ONT during a waiting time and incorporating the estimation in the grant to the ONT. In such an estimation technique, a control gain is used to adjust the estimation based on the difference between the departed and arrived packets in the previous transmission cycle.

For example, the dynamic bandwidth allocation may use an interleaved polling with adaptive cycle time with grant estimation, together with sharing the upstream channel among multiple ONTs. The amount of packets arriving at an ONT between two consecutive pollings is estimated based on the self-similarity characteristic of network traffic, and the OLT decides the granted transmission size for the ONT based on the estimated packet amount as well as the amount requested in the previous polling cycle. By estimating the amount of new arriving packets and granting an additional window size, the grant size to the ONT will be close to the real buffer occupancy at the time when the ONT is polled.

For example, the dynamic bandwidth allocation may use a bandwidth guaranteed polling where the ONTs are divided into two groups: bandwidth guaranteed and bandwidth non-guaranteed. The OLT performs bandwidth allocation through using polling tables. The first polling table divides a fixed-length polling cycle into a number of bandwidth units and each ONT is allocated a certain number of such bandwidth units. The number of bandwidth units allocated to an ONT is determined by the bandwidth demand of that ONT, which is given by its service level agreement. A bandwidth guaranteed ONT with more than one entry in the poling table has its entries spread through the table. This can reduce the average queuing delay because the ONT is polled more frequently.

For example, a fair sharing with dual service level agreements may employ dual service level agreements to manage the fairness for both subscribers and service providers. The primary service level agreement specifies those services whose minimum requirements must be guaranteed with a high priority. The secondary service level agreement describes the service requirements with a lower priority. This technique may first allocate timeslots to those services with the primary service level agreement to guarantee their upstream transmissions. After the services with the primary service level agreement are guaranteed, the next round is to accommodate the secondary service level agreement services. If the bandwidth is not sufficient to accommodate the secondary service level agreement services, a max-min policy is adopted to allocate the bandwidth with fairness.

Traditionally, the dynamic bandwidth allocation is performed locally by the OLT in order to provide for lower latency for the respective ONTs in the amount of data that may be buffered in their respective buffers. Providing effective bandwidth management on a timely basis is desired in order for the ONTs to have responsive data communication with the network. Upon further consideration, it was determined that in the case that the OLT is sufficiently close to the vOLT, then there is relatively low additional latency in the communication between the OLT and the vOLT. Upon further consideration, it was determined that in the case that the OLT is not sufficiently close to the vOLT, then there is relatively high additional latency in the communication between the OLT and the vOLT. The additional latency is more likely to occur in the case of a remote OLT that is located deeper into the access network.

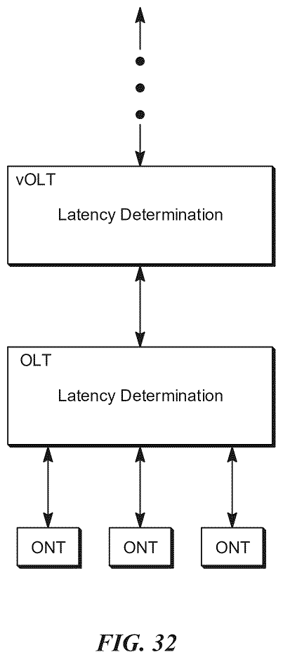

Referring to FIG. 32, to accommodate differences in the latency that may occur as a result of communications between the OLT and the vOLT, the OLT and/or the vOLT may include a latency determination. The latency determination may approximate the additional time it takes for the vOLT to perform a functionality that may otherwise be performed by the OLT, including (if desired) the transmission of data from the OLT to the vOLT and the vOLT to the OLT, and including (if desired) the differences in the time to perform selected calculations.

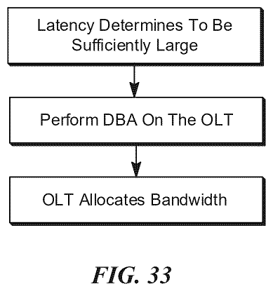

Referring to FIG. 33, when the latency is sufficiently large, such as larger than a threshold, it is desirable to perform the dynamic bandwidth allocation on the OLT so that the latency remains sufficiently low for the dynamic bandwidth allocation for the ONTs. The OLT allocates bandwidth to the ONTs.

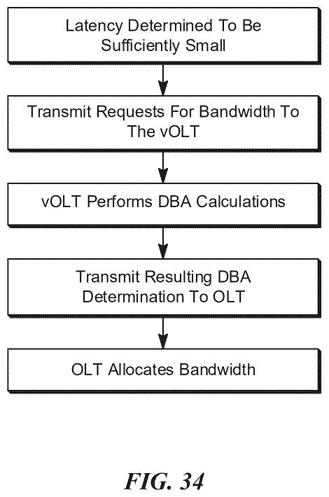

Referring to FIG. 34, when the latency is sufficiently small, such as smaller than a threshold, it is desirable to perform the dynamic bandwidth allocation on the vOLT because the latency still remains sufficiently low for the dynamic bandwidth allocation for the ONTs. The requests for the dynamic bandwidth allocation received from the ONTs may be forwarded to the vOLT, which determines the dynamic bandwidth allocation using its processing capabilities of the server, and transmits the resulting dynamic bandwidth allocation determination to the OLT so that bandwidth may be allocated to the ONTs by the OLT.

The OLT preferably includes a computationally efficient manner of performing dynamic bandwidth allocation, due to the limited computational resources of the OLT. The vOLT is not so limited in its computational resources, so a different technique may be used to perform dynamic bandwidth allocation, that tends to provide a more efficient allocation of the bandwidth. Accordingly, by using the vOLT to perform dynamic bandwidth allocation facilitates the use of different dynamic bandwidth allocation techniques to be used for the same access network.

In the case of micro service and other software structures, they may be operated on the OLT and when desired, may be suspended on the OLT, and a corresponding micro service may be operated on the vOLT. In the case of a micro service and other software structures, they may be operated on the vOLT and when desired, may be suspended on the vOLT, and a corresponding micro service may be operated on the OLT. In this manner, a particular service may be effectively transferred between the vOLT and the OLT, normally together with the state information of the service. Further, a service may co-exist on the vOLT and the OLT to perform processing, with each to perform a portion of the processing for a particular task.

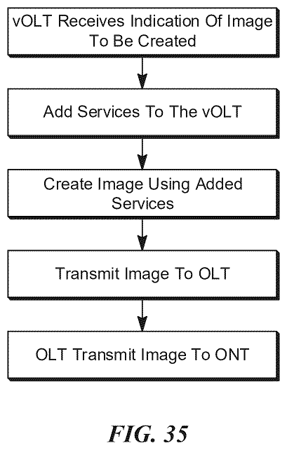

Referring to FIG. 35, there are selected events that the processing for the OLT will be substantial and known in advance of the time for such processing, including when preparing an image update for a ONT that is then pushed out to the ONT across the optical network. When updating hundreds, thousands, or hundreds of thousands of ONTs, the OLT with its limited computational resources has a highly burdensome task to prepare each of the images and then subsequently push them out to the ONTs across the network. With the ability to selectively provide computing resources on the vOLT and the OLT, it is desirable than when such preparing an image update for an ONT, or many ONTs, then it is desirable to create or otherwise transfer a microservice to be within the OLT that is tasked with preparing the image update for each of the ONTs. In this manner, a suitable service may be created or otherwise increasingly scaled prior to the need for such computing resources as they are normally scheduled, and then removal or otherwise decreasingly scaled down the need after for such computing resources. This scheduled computing resource modification facilitates the effective processing that is desired while maintaining the computational resources of the OLT to be relatively low.

⁴Each of the functions related to the ONTs capabilities and management are described, to a greater or lesser extent, by various standards in a terse manner that are, typically arrived at by consensus of a diverse set of entities, each of which tends to have a different viewpoint on the meanings of the description in the standards. Accordingly, each of the ONTs and especially those developed by different manufacturers, may have variations based upon the particular manufacturer's interpretation of the various standards. This tends to be especially true for the control and management functions. ⁴ 6155 Specification Blue

The G.988 standard describes managed entities of a protocol-independent management information base (MIB) that models the exchange of information between OLT and ONT in a PON-based access network that are subject to a standard, such as for example, G.988. See, G.988: ONU management and control interface (OMCI) specification, (11/17); G.988 (2017) Amendment 1 (11/18); G.988 ((2017) Amendment 2 (08/19); G.988 (2017) Amendment 3 (03/2); and G.988 (2017) Amendment 4 (09/21), each of which is incorporated by reference herein in its entirety. G.988 also addresses the ONT management and control channel (OMCC) setup, protocol, and message formats. In addition to interpretation considerations by various manufacturers of the G.988 standard, it is also not often sufficient for complete interoperability between different OLT and ONT manufacturers. There exist various ONTs that are simply not compliant with the various standards because of manufacturer decisions on their implementation.

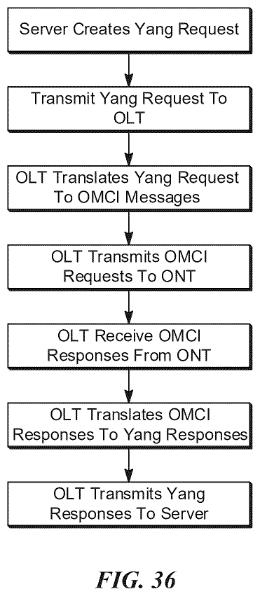

Referring to FIG. 36, one technique to provide an OMCI message to the ONT is for a server at the core network (i.e., any server within the network), to create a virtual OMCI set of microservices that are especially tailored to the functionality for each ONT model of each vendor. The management data maintained by the system is typically defined in terms of YANG data models that comprise modules and submodules that define configuration and state data, notifications, and remote procedure calls for. A YANG module defines a data model through its data, and the hierarchical organization of and constraints on that data. Each module is uniquely identified by a namespace URI. A module defines a single data model. However, a module can reference definitions in other modules and submodules by using the import statement to import external modules or the include statement to include one or more submodules. Additionally, a module can augment another data model by using the augment statement to define the placement of the new nodes in the data model hierarchy and a when statement to define the conditions under which the new nodes are valid. A module uses a feature statement to specify parts of a module that are conditional and the deviation statement to specify where the device's implementation might deviate from the original definition. In this manner, a module can have a large complex set of conditions that accommodate various environments. The core network provides the YANG requests to the OLT which then translates the YANG requests and responses and notifications to and from a vOLTMF (vOLT Management Function) into the OMCI messages, and the OLT transmits and receives the OMCI message requests and responses and notifications to and from the ONT.

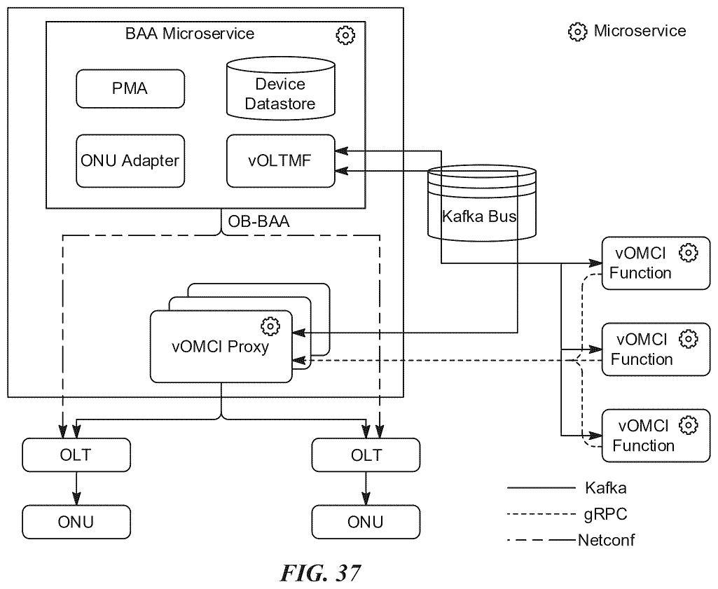

Referring to FIG. 37, a high-level design of a vOLT Management Function (vOLTMF) that may be used to manage ONTs through vOMCI messages is illustrated. There is communication between the vOLTMF, vOMCI Proxy, and vOMCI function based upon creating and deleting ONTs, receiving ont-state-change notifications, and sending requests to ONTs. The vOLTMF manages ONTs through a ONT adapter that may be deployed as broadband access abstraction, the association of which is based on the model, type, vendor, and version mentioned while creating the ONT. The ONT adapter may use a library of the YANG modules for ONTs that the vOLTMF refers to for handling ONT requests, responses, and notifications from external management systems.

The vOLTMF performs actions upon receiving notifications and requests either from an OLT device or other components within the broadband access abstraction core. For example, the onu-state-change notification that is sent by the OLT device on its Northbound Interface (NBI) that is received by broadband access abstraction core. The broadband access abstraction core propagates the notification towards vOLTMF and broadband access abstraction NBI so that it can be handled by the Access SDN M&C.

Upon reception of the notification, the vOLTMF processes the notification, checks if a preconfigured ONU device exists and authenticates the ONU, the vOLTMF transforms the notification to Google Protobufs (GPB) format and propagates the set-onu-communication Action towards the vOMCI function and vOMCI-proxy via the Kafka bus.

All the YANG requests are sent towards the vOMCI function and vOMCI Proxy via the Kafka bus in GPB format. Once the vOMCI function/Proxy processes the requests, the vOMCI function sends the notification/request response in GPB format back to the vOLTMF via the Kafka bus and the response is received through the KafkaNotificationCallback#onNotification( ).

Upon receiving the response, the vOLTMF is responsible for processing the response and performs actions accordingly.

There could be multiple interactions between the vOLTMF and the vOMCI function including parallel configuration requests/commands for either the same or different ONUs. These interactions are parallel and asynchronous such that the requests are not idle/blocked while waiting for responses because the vOLTMF has separate task queues and threadpools to handle the request/response interactions. The following shows the list of vOLTMF threadpools that spawned as new Runnable tasks, namely, processNotificationRequestPool, kafkaCommunicationPool, kafkaPollingPool, processNotificationResponsePool, and processRequestResponsePool. processNotificationRequestPool is used for processing the mediated device event listener callbacks and device notification requests. kafkaCommunicationPool is used to proess individual GET/COPY-CONFIG/EDIT-CONFIG requests inside a MediatedDeviceNetconfSession spawned by preocessRequestResponsePool. kafkaPollingPool is used to tart up the KafkaConsumer implementation and polling for responses from vOMCI-function/vOMCI Proxy. processRequestResponsePool is used for processing notification responses from the vOMCI-function/vOMCI Proxy. The processRequestResponsePool is used for processing GET/COPY-CONFIG/EDIT-CONFIG requests and responses from the vOMCI-function/vOMCI Proxy. In general, the process may be considered a type of protocol adapter to one that operates on an ONT that also works with an OLT in a PON environment. As it may be observed, the manner in which the processing is performed is relatively complex, including Google Protobufs, remote procedure calls, and other complications that require a substantial amount of computational resources to process all the microservices which are burdensome for the OLT.

The YANG models included as part of the TR-451/TR-385/TR-383 specifications permit obtaining performance metrics from the ONTs for defined time periods. The TR-451/TR-385/TR-383 specifications include YANG models to obtain usage statistics for a 5 minute time period for the OLT, a 15 minute time period for the ONT, a 1 hour time period for the ONT, and/or a 24 hour time period for the ONT. This set of usage statistics representing different durations facilitates the management of the ONTs so that their usage may be determined over a day by sending YANG requests on a periodic basis, as desired. In addition, the TR-451/TR-385/TR-383 specifications include YANG models for an “active” state of each of the ONTs so that the current number of bytes in its buffers may be obtained, which is an ‘instantaneous’ measure of usage. With hundreds to thousands of ONTs being managed by the vOMCI it is not desirable to use the YANG model defined by the standard for the “active” state to query each of the ONTs on a continual basis, due to the resulting load on the passive optical network and its components.

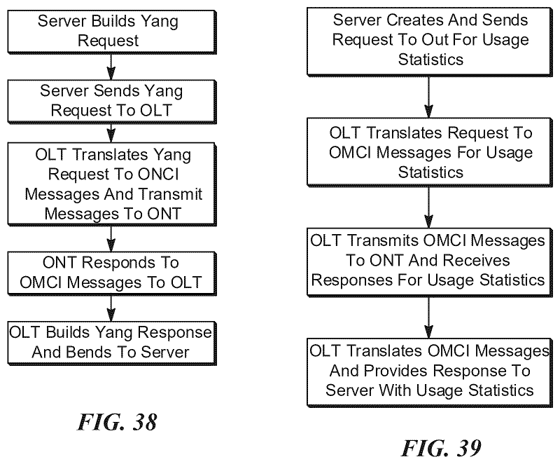

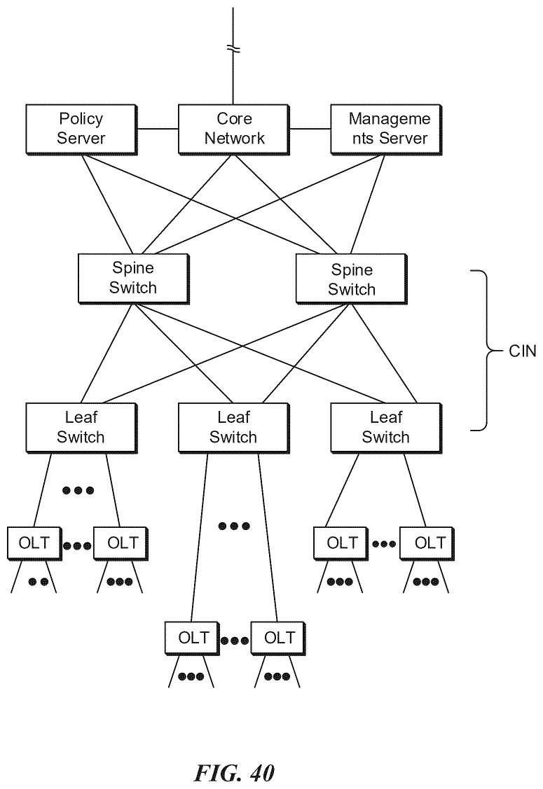

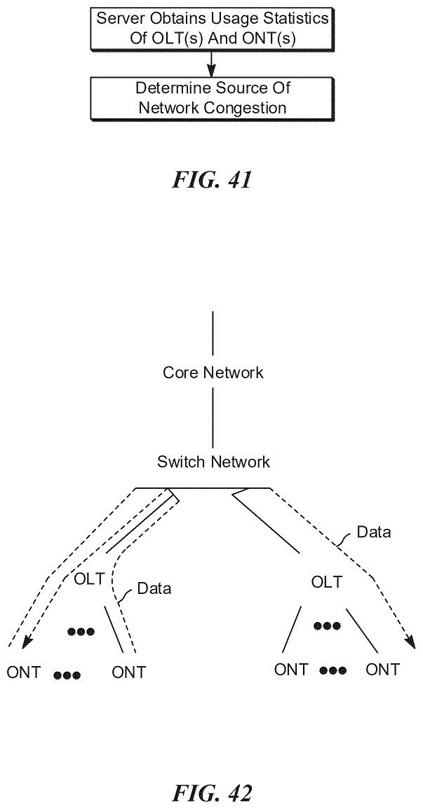

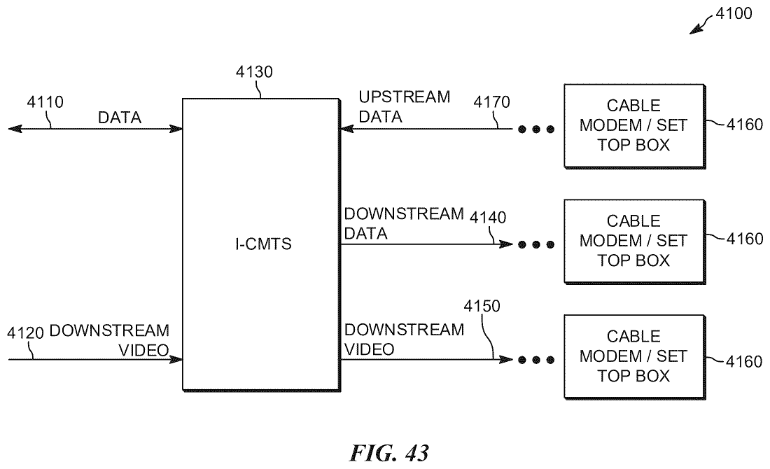

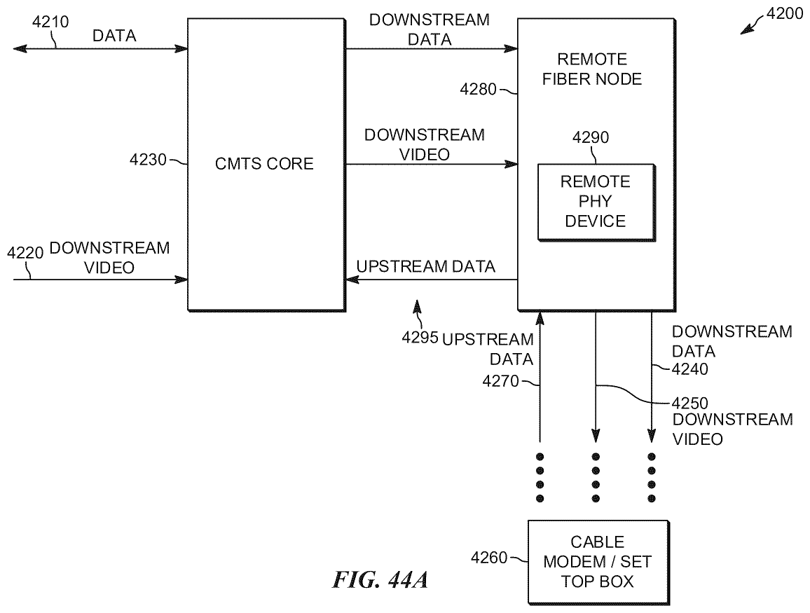

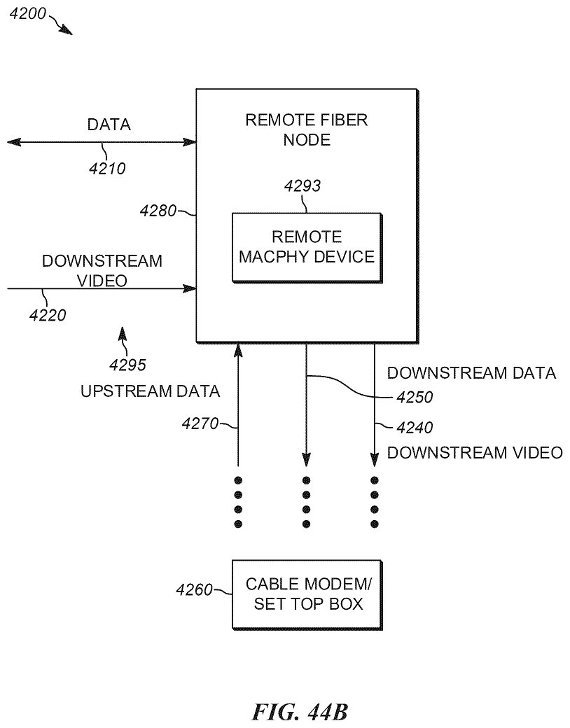

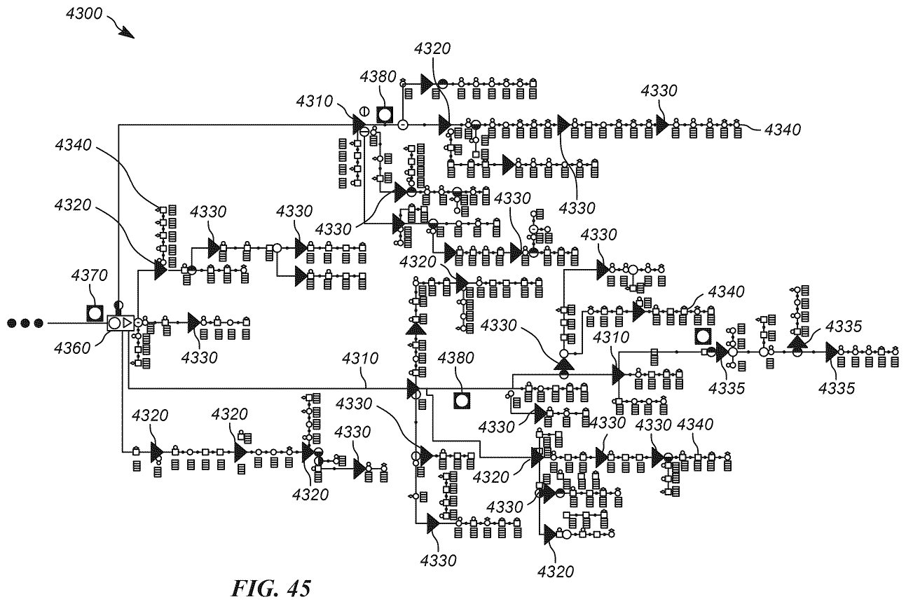

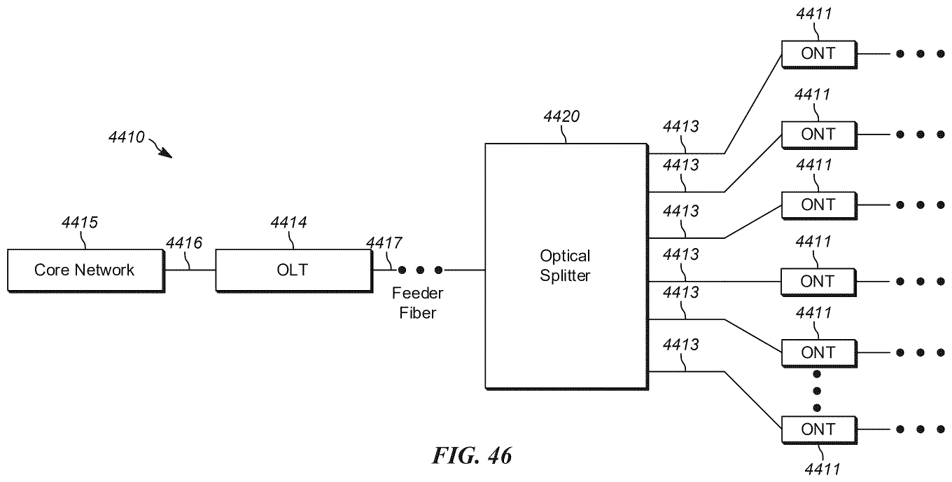

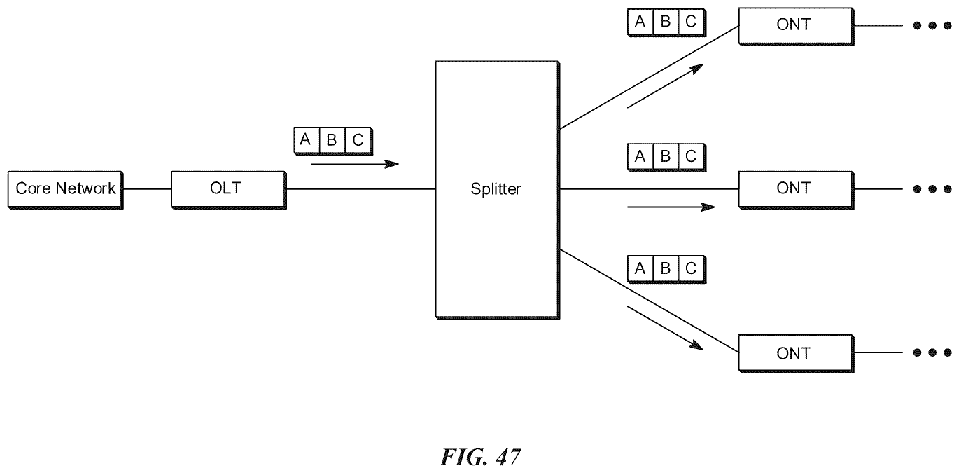

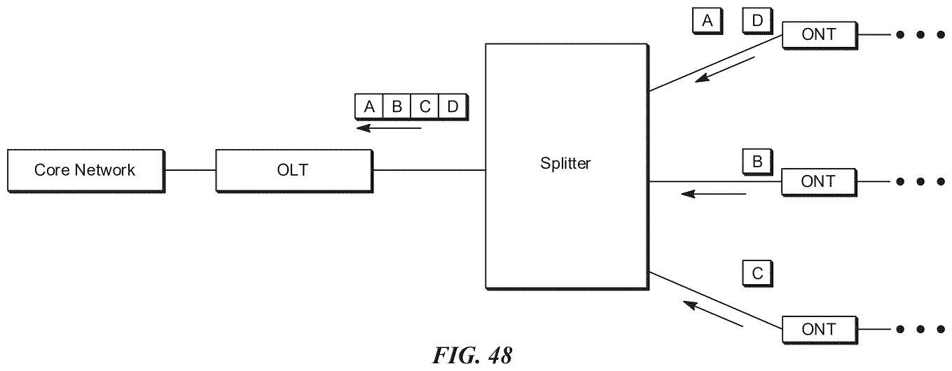

Referring to FIG. 38 and FIG. 39, to provide more effective dynamic bandwidth management, it is desirable to have usage statistics on a time scale of 15 seconds or less, more preferably 10 seconds or less, more preferably 5 seconds or less, more preferably 3 seconds or less, and more preferably 1 second or less. To facilitate such usage statistics, it is desirable to expand the available YANG models to include receiving usage statistics from the ONTs at one or more of the 15, 10, 5, 3 and/or 1 second or less time durations. With the 15 second or less usage statistics, which is distinct from the ‘instantaneous’ usage statistic, the system may more effectively manage the short-term trends in the data usage for the ONTs. For example, if the trend of the data usage for a particular ONT is trending upwards, the dynamic bandwidth allocation may allocate additional bandwidth to the particular ONT. For example, if the trend of the data usage for a particular ONT is trending downwards, the dynamic bandwidth allocation may allocate less bandwidth to the particular ONT. Also, with the short-term trends in the data usage being available, a clearer overall network usage based upon the collective usage of the ONTs on portions of the access network may be determined. If it is not desirable to expand the YANG model to include the updated usage statistics time periods, a REST API, or other model, may be used.

Preferably, the usage metrics are published on a message bus for distribution. The message bus includes a combination of a common data model, a common command set, and a messaging infrastructure to allow different systems to communicate through a shared set of interfaces. In this manner, any device such as a back office management system, may obtain the information from the message bus.

The traditional passive optical network based controller includes a switch card together with 10-20 line cards, each of which includes multiple ports, within a single chassis. The switch card manages all of the line cards and provides a consolidated north bound interface to the core network or as a set of individual devices, which is managed by the switch card. The interconnection to the core network typically uses an optical fiber. With the OLTs being moved farther into the network, together with virtualized services such as the vOLT and/or vOMCI, the passive optical network becomes disaggregated.

Referring to FIG. 40, a passive optical network may include a plurality of optical line terminals (OLTs) that are interconnected to the core network through a network of switches, such as a converged interconnect network (CIN). The CIN provides a fan-out connectivity between multiple node-based OLTs and the core network. The leaf switch and spine switch architecture of the CIN permits effective scalability. In this manner, the passive optical network may support a hundred thousand ONTs or more, as a result of the distributed nature of the architecture. It is desirable to manage the data routing within the CIN by using the vOLT or otherwise a virtualized switch management function.

For example, each device in the CIN topology may make a routing decision on a hop-by-hop basis by comparing a destination IP address of the packet to a routing or forwarding table. A preferable manner of making a routing decision is based upon a Multiprotocol Label Switching (MPLS) label contained in the packet that is received. In this manner, the switches do not necessarily require IP routing information about all designations, as long as they know how to forward traffic based on a MPLS label. When a subscriber is added to an OLT, the OLT and/or vOLT may configure the CIN topology for a suitable Multiprotocol Label Switching (MPLS) label for making a routing decision. By way of example, a S tag may be provided to route to a particular leaf switch and a C tag may be provided to map to a particular port associated with the particular leaf switch.

Referring to FIG. 41, the usage statistics may be obtained for the usage of the OLT and for the usage of each of the ONTs at a granular basis. With such usage statistics the source of congestion may be distinguished by the system, such as the core network. For example, if a particular ONT shows congestion while the corresponding OLT does not show any similar congestion, then it may be reasonably inferred that the ONT itself is the source of the congestion. For example, if all or a sufficient number of ONTs associated with an OLT do not show congestion while the corresponding OLT does show congestion, then it may be reasonably inferred that the OLT itself is the source of the congestion. For example, if all or a sufficient number of ONTs associated with an OLT do not show congestion and the corresponding OLT does not show congestion, then it may be reasonably inferred that the CIN network is the source of the congestion.

Referring to FIG. 42, it was determined that a substantial amount of data tends to be from a local geographic area that is shared among a group of users. For example, audio and/or video conferencing shared among a set of gamers may be within the geographic reach of a single OLT. In this manner, a substantial amount of the data traffic is within the confines of a single OLT. For example, audio and/or video conferencing among a set of gamers may be within the geographic reach of a set of OLTs associate with a single core network and/or CIN. In this manner, a substantial amount of the data traffic is within the confines of the set of OLTs. In one embodiment, to accommodate such geographically clustered subscribers, it is desirable to configure the CIN network such that data from one OLT may be redirected within the CIN network to another OLT within the CIN network without having to be provided to the core network. In another embodiment, to accommodate such geographically clustered subscribers, it is desirable to configure the CIN network such that data from one OLT may be redirected within the CIN network to the same OLT without having to be provided to the core network. In this manner, the data bandwidth of the interface to the core network remains available for other data.

⁵Cable Television (CATV) services provide content to large groups of customers (e.g., subscribers) from a central delivery unit, generally referred to as a “head end,” which distributes channels of content to its customers from this central delivery unit through an access network comprising a hybrid fiber coax (HFC) cable plant, including associated components (nodes, amplifiers and taps). Modern Cable Television (CATV) service networks, however, not only provide media content such as television channels and music channels to a customer, but also provide a host of digital communication services such as Internet Service, Video-on-Demand, telephone service such as VoIP, home automation/security, and so forth. These digital communication services, in turn, require not only communication in a downstream direction from the head end, through the HFC, typically forming a branch network and to a customer, but also require communication in an upstream direction from a customer to the head end typically through the HFC network. ⁵ 6330 Specification Red

To this end, CATV head ends have historically included a separate Cable Modem Termination System (CMTS), used to provide high speed data services, such as cable Internet, Voice over Internet Protocol, etc. to cable customers and a video headend system, used to provide video services, such as broadcast video and video on demand (VOD). Typically, a CMTS will include both Ethernet interfaces (or other more traditional high-speed data interfaces) as well as radio frequency (RF) interfaces so that traffic coming from the Internet can be routed (or bridged) through the Ethernet interface, through the CMTS, and then onto the RF interfaces that are connected to the cable company's hybrid fiber coax (HFC) system. Downstream traffic is delivered from the CMTS to a cable modem and/or set top box in a customer's home, while upstream traffic is delivered from a cable modem and/or set top box in a customer's home to the CMTS. The Video Headend System similarly provides video to either a set-top, TV with a video decryption card, or other device capable of demodulating and decrypting the incoming encrypted video services. Many modern CATV systems have combined the functionality of the CMTS with the video delivery system (e.g., EdgeQAM-quadrature amplitude modulation) in a single platform generally referred to an Integrated CMTS (e.g., Integrated Converged Cable Access Platform (CCAP))-video services are prepared and provided to the I-CCAP which then QAM modulates the video onto the appropriate frequencies. Still other modern CATV systems generally referred to as distributed CMTS (e.g., distributed Converged Cable Access Platform) may include a Remote PHY (or R-PHY) which relocates the physical layer (PHY) of a traditional Integrated CCAP by pushing it to the network's fiber nodes (R-MACPHY relocates both the MAC and the PHY to the network's nodes). CableLabs specifications refer to this architecture as a Distributed Access Architecture (DAA) with Flexible MAC Architecture (FMA). Thus, while the core in the CCAP performs the higher layer processing, the R-PHY device in the remote node converts the downstream data sent from the core from digital-to-analog to be transmitted on radio frequency to the cable modems and/or set top boxes, and converts the upstream radio frequency data sent from the cable modems and/or set top boxes from analog-to-digital format to be transmitted optically to the core.

Referring to FIG. 43, an integrated CMTS (e.g., Integrated Converged Cable Access Platform (CCAP)) 4100 may include data 4110 that is sent and received over the Internet (or other network) typically in the form of packetized data. The integrated CMTS 4100 may also receive downstream video 4120, typically in the form of packetized data from an operator video aggregation system. By way of example, broadcast video is typically obtained from a satellite delivery system and pre-processed for delivery to the subscriber though the CCAP or video headend system. The integrated CMTS 4100 receives and processes the received data 4110 and downstream video 4120. The CMTS 4130 may transmit downstream data 4140 and downstream video 4150 to a customer's cable modem and/or set top box 4160 through a RF distribution network, which may include other devices, such as amplifiers and splitters. The CMTS 4130 may receive upstream data 4170 from a customer's cable modem and/or set top box 4160 through a network, which may include other devices, such as amplifiers and splitters. The CMTS 4130 may include multiple devices to achieve its desired capabilities.

Referring to FIG. 44A, as a result of increasing bandwidth demands, limited facility space for integrated CMTSs, and power consumption considerations, a Distributed Cable Modem Termination System (D-CMTS) 4200 (e.g., Distributed Converged Cable Access Platform (CCAP)) may be used. CableLabs specifications refer to this architecture as a Distributed CCAP Architecture (DCA) in the Flexible MAC Architecture (FMA) specifications. In general, the CMTS is focused on data services while the CCAP further includes broadcast video services. The D-CMTS 4200 distributes a portion of the functionality of the I-CMTS 4100 downstream to a remote location, such as a fiber node, using network packetized data. An exemplary D-CMTS 4200 may include a remote PHY architecture, where a remote PHY (R-PHY) is preferably an optical node device that is located at the junction of the fiber and the coaxial. In general, the R-PHY often includes the PHY layers of a portion of the system. The D-CMTS 4200 may include a D-CMTS 4230 (e.g., core) that includes data 4210 that is sent and received over the Internet (or other network) typically in the form of packetized data. The D-CMTS 4230 is referred to as the Remote MAC Core (RMC) in the Flexible MAC Architecture (FMA) CableLabs specifications. The D-CMTS 4200 may also receive downstream video 4220, typically in the form of packetized data from an operator video aggregation system. The D-CMTS 4230 receives and processes the received data 4210 and downstream video 4220. A remote fiber node 4280 preferably include a remote PHY device (RPD) 4290. The RPD 4290 may transmit downstream data 4240 and downstream video 4250 to a customer's cable modem and/or set top box 4260 through a network, which may include other devices, such as amplifier and splitters. The RPD 4290 may receive upstream data 4270 from a customer's cable modem and/or set top box 4260 through a network, which may include other devices, such as amplifiers and splitters. The RPD 4290 may include multiple devices to achieve its desired capabilities. The RPD 4290 primarily includes PHY related circuitry, such as downstream QAM modulators, upstream QAM demodulators, together with psuedowire logic to connect to the D-CMTS 4230 using network packetized data. The RPD 290 and the D-CMTS 4230 may include data and/or video interconnections, such as downstream data, downstream video, and upstream data 4295. It is noted that, in some embodiments, video traffic may go directly to the RPD thereby bypassing the D-CMTS 4230. In some cases, the remote PHY and/or remote MACPHY functionality may be provided at the head end.

Referring to FIG. 44B, a modified distributed architecture includes a remote MACPHY device (RMD) 4293 included within the remote fiber node 4280.

By way of example, the RPD 4290 may covert downstream DOCSIS (i.e., Data Over Cable Service Interface Specification) data (e.g., DOCSIS 1.0; 1.1; 2.0; 3.0; 3.1; and 4.0 each of which are incorporated herein by reference in their entirety), video data, out of band signals received from the D-CMTS 4230 to analog for transmission over RF or analog optics. By way of example, the RPD 4290 may convert upstream DOCSIS, and out of band signals received from an analog medium, such as RF or linear optics, to digital for transmission to the D-CMTS 4230. As it may be observed, depending on the particular configuration, the R-PHY may move all or a portion of the DOCSIS MAC and/or PHY layers down to the fiber node.

The amount of data services supported by DOCSIS based networks over time has been increasing. To support the ever-increasing data capacity needs, the DOCSIS standard has likewise been evolving in a manner to support the increasing data capacity needs. A single-carrier quadrature amplitude modulation (SC-QAM) based transmission of DOCSIS 3.0 is giving way to orthogonal frequency division multiplexing (OFDM) and orthogonal frequency division multiple access (OFDMA) of DOCSIS 3.1, to support greater megabits per second (Mbps) per mega-hertz (MHz) of spectrum. Furthermore, more MHz of radio frequency (RF) spectrum yields more Mbps, thus a wider spectrum, for both downstream (DS) and upstream (US) transmission is another manner in which the DOCSIS standard has evolved. For example, the DOCSIS standard has evolved from (1) 5-85 MHz US with 102-1002 MHz DS supported by DOCSIS 3.0 to (2) 5-204 MHz US with 258-1218 MHz DS of DOCSIS 3.1, and (3) 5-682 MHz US with 108-1794 MHz DS of DOCSIS 4.0. Transmitted spectrum width increase, in DS especially, affects how the network is architected. The DOCSIS 3.1 to DOCSIS 4.0 transition, from 1,218 MHz highest DS frequency to 1,794 MHz highest DS frequency, envisions a change from a centralized access architecture (CAA) to distributed access architecture (DAA), in order to support higher OFDM modulation formats and thus improved spectral density at the DAA nodes.

Referring to FIG. 45, an exemplary hybrid fiber coaxial network 4300 may be comprised of a variety of different components. The hybrid fiber coaxial network 4300 may include a set of trunk amplifiers 4310. The hybrid fiber coaxial network 4300 may include a set of bridge amplifiers 4320. The hybrid fiber coaxial network 4300 may include a set of line extenders 4330. The hybrid fiber coaxial network 4300 may include a set of ports 4340, such as 2 ports, 4 ports, and 8 ports, that provide service to selected groups of customers. The core (e.g., CMTS) or otherwise a source of the data provides data and receives data to and from, respectively, a remote node 4360 which provides a conversion from an optical fiber to a coaxial cable interconnection. Power from a power source 4370 is normally provided through the coaxial cable, such as 60 volts or 90 volts, so that optical nodes, trunk and distribution amplifiers do not need an individual, external power source. Also, within the network, power is typically injected into the network at various locations 4380, where an external power source is available. As it may be observed, the resulting hybrid fiber coaxial network 4300 tends to be relatively complicated in its nature and the customers share the bandwidth that is available across the network.

To increase the bandwidth to the customers, the frequencies used for the data transmission can be increased together with different modulation schemes used so that increased data may be transmitted to and from the customers. For example, this may be achieved by modifying the network to accommodate DOCSIS 3.1 from DOCSIS 3.0, and DOCSIS 4.0 from DOCSIS 3.1. While this tends to achieve some limited success, when the network needs to support higher data capacity, it tends to be advantageous to modify the traditional integrated CMTS environment to a distributed access architecture, where the remote-PHY and/or remote MACPHY, are located in remote fiber nodes deeper in the network. The interconnection from the core network to the remote fiber nodes are typically optical fibers, which when used in conjunction with remote-PHY and/or remote MACPHY, further increase the data carrying capacity for the customers. Further, to increase the data carrying capabilities of the network, the data interconnections over the optical fiber are preferably digital rather than analog, and more preferably all digital which reduces interference and cross talk that may otherwise occur when analog signals exist within the optical fiber. By way of example, remote-PHY may use DEPI in the downstream path and UEPI in the upstream path. By way of example, remote-MACPHY may use Ethernet in the downstream path and Ethernet in the upstream path. Accordingly, as an initial change the traditional integrated CMTS based system may be modified to include remote-PHY and/or remote MACPHY, which provides an additional benefit of including optical fiber deeper into the network.

Rather than further segregate the network into smaller service groups to be serviced by an increasing number of remote-PHY and/or remote MACPHY, it is preferable to further include passive optical networking technologies to service selected customers. Passive optical networking technologies provide for ever increasing data carrying capacities for selected customers. Passive optical networks traditionally include a set of optical line terminals at the head end with an optical network terminal at each of the customers. In this manner, optical signals compliant with a particular passive optical network communication protocol, are provided from the head end to the respective customers.

A passive optical network (PON) is often employed as an access network, or a portion of a larger communication network. The communication network typically has a high-capacity core portion where data or other information associated with telephone calls, digital television, and Internet communications is carried substantial distances. The core portion may have the capability to interact with other networks to complete the transmission of telephone calls, digital television, and Internet communications. In this manner, the core portion in combination with the passive optical network enables communications to and communications from subscribers (or otherwise devices associated with a subscriber, customer, business, or otherwise).

The access network of the communication network extends from the core portion of the network to individual subscribers, such as those associated with a particular residence location (e.g., business location). The access network may be wireless access, such as a cellular network, or a fixed access, such as a passive optical network or a cable network.

Referring to FIG. 46, in a PON 4410, a set of optical fibres and passive interconnecting devices are used for most or all of the communications through the extent of the access network. A set of one or more optical network terminals (ONTs) 4411 are devices that are typically positioned at a subscriber's residence location (e.g., or business location). The term “ONT” includes what is also referred to as an optical network unit (ONU). There may be any number of ONTs associated with a single optical splitter 4412. By way of example, 32 or 64 ONTs are often associated with the single network optical splitter 4412. The optical splitter 4412 is interconnected with the respective ONTs 4411 by a respective optical fiber 4413, or otherwise a respective fiber within an optical fiber cable. Selected ONTs may be removed and/or added to the access network associated with the optical splitter 4412, as desired. There may be multiple optical splitters 4412 that are arranged in a cascaded arrangement.

The optical fibers 4413 interconnecting the optical splitter 4412 and the ONTs 4411 act as access (or “drop”) fibers. The optical splitter 4412 is typically located in a street cabinet or other structure where one or more optical splitters 4412 are located, each of which are serving their respective set of ONTs. In some cases, an ONT may service a plurality of subscribers, such as those within a multiple dwelling unit (e.g., apartment building). In this manner, the PON may be considered a point to multipoint topology in which a single optical fiber serves multiple endpoints by using passive fiber optic splitters to divide the fiber bandwidth among the endpoints.

An optical line terminal (OLT) 4414 is located at the central office where it interfaces directly or indirectly with a core network 4415. An interface 4416 between the OLT 4414 and the core network 4415 may be one or more optical fibers, or any other type of communication medium. The OLT 4414 forms optical signals for transmission downstream to the ONTs 4411 through a feeder optical fiber 4417, and receives optical signals from the ONTs 4411 through the feeder optical fiber 4417. The optical splitter 4412 is typically a passive device that distributes the signal received from the OLT 4414 to the ONTs 4411. Similarly, the optical splitter 4412 receives optical signals from the ONTs 4411 and provides the optical signals though the feeder optical fiber 4417 to the OLT 4414. In this manner, the PON includes an OLT with a plurality of ONTs, which reduces the amount of fiber necessary as compared with a point-to-point architecture.

As it may be observed, an optical signal is provided to the feeder fiber 4417 that includes all of the data for the ONTs 4411. Accordingly, all the data being provided to each of the ONTs is provided to all the ONTs through the optical splitter 4412. Each of the ONTs selects the portions of the received optical signals that are intended for that particular ONT and passes the data along to the subscriber, while discarding the remaining data. Typically, the data to the ONTs are time divisional multiplexed to the feeder fiber 4417, and similarly time division multiplexed to each of the ONTs.

Upstream transmissions from the ONTs 4411 through the respective optical fibers 4413 are typically transmitted in bursts according to a schedule provided to each ONT by the OLT. In this way, each of the ONTs 4411 will transmit upstream optical data at different times. In some embodiments, the upstream and downstream transmissions are transmitted using different wavelengths of light so that they do not interfere with one another. In this manner, the PON may take advantage of wavelength-division multiplexing, using one wavelength for downstream traffic and another wavelength for upstream traffic on a single mode fiber.

The schedule from the OLT allocates upstream bandwidth to the ONTs. Since the optical distribution network is shared, the ONT upstream transmission would likely collide if they were transmitted at random times. The ONTs typically lie at varying distances from the OLT and/or the optical splitter, resulting in a different transmission delay from each ONT. The OLT measures the delay and sets a register in each ONT to equalize its delay with respect to the other ONTs associated with the OLT. Once the delays have been accounted for, the OLT transmits so-called grants in the form of grant maps to the individual ONTs. A grant map is a permission to use a defined interval of time for upstream transmission. The grant map is dynamically recalculated periodically, such as for each frame. The grant map allocates bandwidth to all the ONTs, such that each ONT receives timely bandwidth allocation for its service needs. Much of the data traffic, such as browsing websites, tends to have bursts and tends to be highly variable over time. By way of a dynamic bandwidth allocation (DBA) among the different ONTs, a PON can be oversubscribed for upstream traffic.

Referring to FIG. 47, the PON network is based upon a point to multi-point downstream transmission arrangement. The data from the OLT is transmitted to all of the ONTs that are interconnected thereto. The data from the OLT is transmitted in the form of one or more frames, where each frame includes data for one or more of the ONTs. For example, in GPON a constant of 125 μs frame is used, where each frame includes (among other control information) an allocation map which informs on the slots granted to allocation ids. Accordingly, each frame is broken up into one or more timeslots that are designated for a corresponding selected one of the ONTs.

Referring to FIG. 48, the PON network is based upon a multi-point to point upstream transmission arrangement using a time divisional multiple access mechanism. The OLT assigns timeslots (BWmaps) for each ONT to transmit its upstream transmission to ensure a collision free transmission. The data from each of the ONTs is transmitted to the corresponding OLT that it is interconnected thereto. The data from the ONT is transmitted in the form of a portion of one or more frames, where each frame includes data for one or more of the ONTs. For example, in GPON a reference frame of 125 μs frame is used, which is not an absolute value since a round of allocations may span through multiple upstream frames. GPON uses a Generic Encapsulation Method (GEM), which allows for the transport, segmentation and reassembly of Ethernet frames and legacy traffic (ATM or TDM). Accordingly, each frame is broken up into one or more timeslots that are designated for a corresponding selected one of the ONTs.

However, with such a passive optical network based configuration a first optical fiber is provided from the head end to the remote fiber node with coaxial cables from the remote fiber node to the customers for the DOCSIS based communications, and a second optical fiber is provided from the head end to selected customers that were previously provided with data communications from the remote fiber node. As it may be observed, this type of network configuration results in duplication of at least a portion of the optical fiber from the head end towards the selected customers, which increases the complexity of the system.

Rather than use such a passive optical network, it was determined that at least a portion of the optical fiber from the head end towards the selected customers may be used by both the DOCSIS based communications and the passive optical network based communications by including one or more remote optical line terminals, which are located deeper into the network.

Referring to FIG. 49, it is often desirable in some installations to locate the optical line terminal at a location remote from the core network, generally referred to as a remote optical line terminal (OLT). The remote OLT may include one or more feeds from the core network to the remote OLT. The remote OLT may then distribute data to a plurality of ONTs and receive data from the plurality of ONTs. Each of the ONTs in turn provides data to and receives data from customer devices. The remote OLT typically has the capability of providing services to a few hundred to a few thousand ONTs.

Referring to FIG. 50 and to FIG. 51, a remote fiber node 4800 that includes DOCSIS based coaxial communications may be included in the network where optical fiber 4810 is provided from the core network to the remote fiber node 4800. The remote fiber node 4800 also preferably also includes associated power 4820, that is provided from a source external to the network, which is used to power any components at the remote fiber node. The remote fiber node may include the transition from the optical fiber to the coaxial cable. The remote fiber node may include a remote-PHY and/or a remote-MACPHY, if desired. The remote fiber node 4800 also preferably includes a co-located remote optical line terminal. The remote optical line terminal also includes interconnected optical fiber to selected customers that were previously provided with data connectivity from the DOCSIS based coaxial communications, to provide data connectivity using a passive optical network-based communication technique. In this manner, the same optical fiber 4810 may provide data connectivity from the core network to the DOCSIS based coaxial transmissions and to the remote optical line terminal, which reduces the complexity of the system. Also, the remote fiber node preferably includes the optical-to-coaxial transition and the remote-OLT within a single housing, both of which are interconnected to the same external power source. The inclusion of the remote-OLT powered by the cabling system is not as preferably because of a limited power that may be provided by the cabling system. Further, a switch and/or router is included with the node to direct the data traffic to the appropriate device.

In an alternative embodiment, an optical line terminal may be included at the head end and use a fiber link module the output thereof, which converts the passive optical network based communication technique to an Ethernet based communication to the remote fiber node. At the remote fiber node, the signals from the optical line terminal from the fiber link module are received and converted back to the passive optical network based communication protocol using a corresponding fiber link module, with the data being provided to corresponding customers using the passive optical network based communication protocol.

The remote-OLT preferably includes data service to a majority (greater than 50%) of the high data usage customers (top 10%) of a particular remote fiber node where the corresponding optical fibers are installed together with ONTs. Also, the majority of the bottom low data usage customers (bottom 90%) are provided service by the hybrid-to-coaxial device. The remaining customers are serviced by the remaining HFC network, which then has substantially less data being carried on its network and as a result may provide effective data service. Also, the newly installed optical fibers preferably follow the same path as the existing coaxial cables, such as underground tunnel and conduit paths and above ground pole-to-pole paths.

Moreover, each functional block or various features in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1-23. (canceled)

24. An access network for a passive optical network comprising:
(a) an optical line terminal includes a north bound interface that is capable of receiving and sending data from and to a server, respectively;
(b) said optical line terminal includes a port that is capable of receiving and sending optical data from and to a set of optical network terminals, respectively, through an optical fiber;
(c) a virtual optical line terminal running on said server operably interconnected with said optical line terminal;
(d) said virtual optical line terminal encoding and/or decoding data to be provided to said set of optical network terminals and/or to a core network using forward error correction.

25. The access network of claim 24 wherein said virtual optical line terminal is configured to receive data from said core network and perform said forward error correction on said data prior to transmitting forward error corrected data to said optical line terminal.

26. The access network of claim 24 wherein said virtual optical line terminal is configured to receive data from said core network and transmit said data to said optical line terminal, said optical line terminal is configured to transmit said data to said virtual optical line terminal which is configured to perform said forward error correction on said data and transmit said forward error corrected data to said optical line terminal, said optical line terminal is configured to transmit said forward error corrected data to said optical line terminal.

27. The access network of claim 24 wherein said optical line terminal is configured to receive encoded forward error corrected data from one of said optical network terminals and transmits said encoded forward error corrected data to said virtual optical line terminal to decode said forward error corrected data prior to said virtual optical line terminal transmitting decoded forward error corrected data to said core network.

28. The access network of claim 24 wherein said optical line terminal is configured to receive encoded forward error corrected data from one of said optical network terminals and transmits said encoded forward error corrected data to said virtual optical line terminal to decode said forward error corrected data, said virtual optical line terminal configured to transmit said decoded forward error corrected data to said optical line terminal prior to said virtual optical line terminal transmitting decoded forward error corrected data to said core network.

29. An access network for a passive optical network comprising:
(a) an optical line terminal includes a north bound interface that is capable of receiving and sending data from and to a server, respectively;
(b) said optical line terminal includes a port that is capable of receiving and sending optical data from and to a set of optical network terminals, respectively, through an optical fiber;
(c) a virtual optical line terminal running on said server operably interconnected with said optical line terminal;
(d) a latency determination module determining a latency; and
(e) at least one of said virtual optical line terminal and said optical line terminal selectively calculating a dynamic bandwidth allocation based upon said latency.

30. The access network of claim 29 further comprising said optical line terminal determining said latency.

31. The access network of claim 29 further comprising said virtual optical line terminal determining said latency.

32. The access network of claim 31 wherein said latency is based upon a time to transmit data from said optical line terminal to said virtual optical line terminal.

33. The access network of claim 31 wherein said latency is based upon a time to transmit data from said virtual optical line terminal to said optical line terminal.

34. The access network of claim 29 further comprising said optical line terminal determining said latency.

35. The access network of claim 34 wherein said latency is based upon a time to transmit data from said optical line terminal to said virtual optical line terminal.

36. The access network of claim 34 wherein said latency is based upon a time to transmit data from said virtual optical line terminal to said optical line terminal.

37. The access network of claim 29 wherein said virtual optical line terminal includes a first dynamic bandwidth allocation technique and said optical line terminal includes a second dynamic bandwidth allocation technique, wherein said first dynamic bandwidth allocation technique is different than said second dynamic bandwidth allocation technique.

38. An access network for a passive optical network comprising:
(a) a virtual optical line terminal running on said server operably interconnected with an optical line terminal including a north bound interface that is capable of receiving and sending data from and to a server, respectively, and a port that is capable of receiving and sending optical data from and to a set of optical network terminals, respectively, through an optical fiber;
(b) said virtual optical line terminal adding additional computing processes as a result of receiving an indication that an image is to be provided to one of said optical network terminals;
(c) said virtual optical line terminal receiving data which is used by said virtual optical line terminal to create said image using said additional computing processes;
(d) said virtual optical line terminal providing said image to said optical line terminal to be provided to said one of said optical network terminals.

39-61. (canceled)
